(19) United States
(12) Patent Application Publication
(10) Pub. No.: US 2011/0179978 A1
(43) Pub. Date: Jul. 28, 2011

(54) PALLET FOR THE HANDLING OF GOODS, PROCESS FOR MANUFACTURING A PALLET AND METHOD FOR PROVIDING PALLETS

(75) Inventor: Karl-Heinz Schmitt, Rynfeild (ZA)

(73) Assignee: Pieter Wouter DU TOIT, Southern Paarl (ZA)

(21) Appl. No.: 12/695,640

(22) Filed: Jan. 28, 2010

(51) Int. Cl. B65D 19/38; B65D 19/22; B29C 41/42

(52) U.S. Cl. 108/53.3; 108/51.11; 264/334

(57) ABSTRACT

Processes and a pallet (10) are provided for the handling of goods. The pallet (10) includes a main body (12) defining a load deck (16) and feet (18) and the main body (12) is suitable to be used as a pallet for applications such as light duty, one-way transport of goods. The pallet (10) further includes a bottom accessory (14) that can be attached to the feet (18) of the main body (12) to form beams (44,46) extending between the feet (18) to convert the main body (12) into pallet (10) that is suitable for use in heavy duty applications such as in pallet pools. The main body (12) and bottom accessory (14) are each configured to allow them to be nested, when not attached to each other. The processes of the invention include using the main body (12) to transport goods from manufacturers and then attaching the bottom accessory (14) to the main body (12) to form a pallet (10) for use in a pallet pool.

### FIELD OF THE INVENTION

This invention relates to pallets for the handling of goods (including transport and storage of the goods) and extends to methods of manufacturing the pallets and methods of providing pallets for the handling of goods.

### BACKGROUND TO THE INVENTION

Pallets are used on a very large scale in the handling of goods and efforts are made continually to reduce the cost of pallets, improve their mechanical properties, extend their service life, etc.

There are various specifications that pallets need to meet for various applications, but some of the divisions that can be used to classify patents, include whether or not pallets are returnable (e.g. to a supplier who supplies goods on the pallet), stackable (i.e. loaded pallets resting on the loads of pallets below) rack-able (i.e. pallets can slide into racks and support loads for extended periods), light weight, heavy duty. Depending on which of these properties are required in a pallet (in addition to common requirements such as cost, strength, repair-ability, etc), the design of a pallet is typically a compromise between different attributes and there is a continuous need to improve the overall properties of pallets while inhibiting compromises.

One of the problems experienced in the pallet industry, is that suppliers of bulk products, e.g. polymer manufacturers, need to transport their products to customers on pallets, but they do not wish to be saddled with the task of retrieving pallets after products have been delivered. They see pallets as a consumable packaging cost. They thus typically supply products on non-returnable pallets and in order to keep costs to a minimum, the pallets are made light in weight (typically about 60 lbs) and with only sufficient strength to carry the load of the goods being loaded. The pallets are typically not made durable enough and/or do not have the mechanical strength to allow them to be used in other applications, such as heavier loading, stacking, racking, or the like on a continuous basis. These light-weight non-returnable one way pallets (referred to in the art as “export pallets”, “white pallets” or “one way pallets”) are thus typically discarded at their destinations, causing wastage in the cost of the pallets and causing a burden on the environment.

Most export pallets are presently being made of wood, but in many countries, suitable timber is not available for making pallets and the timber pallets either have to be imported at great expense, or the timber needs to be imported at similar, although slightly lower, expense and the pallets need to be manufactured, burdening manufacturers of products with costs and/or effort. Further, apart from the obvious environmental impact of deforestation caused by the supply of timber for pallets, the transport of timber pallets (or timber for pallets) increases gas emissions.

Once export pallets reach their destinations, they are typically discarded, because they are not suitable for use as so-called “pool pallets” that are made for use in different applications such as stacking and racking and are re-used repeatedly. The export pallets thus cause further environmental burden because they are either discarded directly as solid waste, or they have to be dismantled (depending on the type of pallet) and their materials disposed of in a suitable manner, such as incineration.

In many countries, “disposal fees” are levied before a timber pallet is allowed to enter the country and/or the pallet needs to be fumigated, heat treated or the like.

Another problem experienced in the pallet industry is the need to transport unloaded pallets cost effectively—whether during the supply of pallets to a user, the retrieval of pallets, or the like. The main problem in this respect is that pallets are bulky by their nature (which is to provide an elevated load platform with space underneath for lifting forks) and unloaded pallets thus occupy large volumes.

Another problem is one of labour because wooden pallet loads received in one country could have a need to be repacked on a different size pallet that fits the automated warehouse requirements.

Another problem experienced in the pallet industry is the need to repair pallets that become damaged. In some cases, it is cost-effective to repair pallets, typically by removing broken parts and replacing them with new parts. It is for instance common practice to remove broken slats in wooden pallets and replace them. However, in many instances, the parts of pallets cannot be separated easily and they are simply discarded when damaged, or the connections between parts of pallets are damaged easily and the pallets cannot be re-assembled with sufficient strength.

Yet another problem experienced in the pallet industry is that the attachment formations of multiple component pallets break during extended use of the pallets, because they are exposed to various loads such as impacts from lifting forks, impacts while the empty pallets are handled, etc.

Yet another problem experienced in the pallet industry is that there are different standard pallet sizes that are used for different types of goods, load weights, storing configurations (e.g. with or without stacking and/or racking), etc. The space constraints in different areas where the pallets need to be stored vary and as a result, pallet sizes that are suitable for one application, e.g. for handling fast-moving consumer goods are not necessarily of a size that allows optimal use of the floor space available in a standard freight container or an automated warehouse racking system.

Some export pallets are made with tapered feet that allow a number of the pallets to nest on top of each other and thus to save space when not loaded. However, the hollow feet of these pallets create large discontinuities in their load decks that detract from the structural strength and stability (stiffness) in the regions of the feet.

In some moulded pallets, ribs are provided in the pallet's structure, especially under its load deck, to improve the strength of the pallet, especially its bending strength. However, in order to de-mould the pallet after moulding it, the moulds have to be made with draft angles and the result is that the ribs have tapered cross-sectional profiles that are wider at one end than the opposite end. These tapered profiles do not provide optimal strength, require additional material to be used in the pallet and thus add to the cost of the pallets.

The present invention seeks to address these problems in a cost-effective manner.

### SUMMARY OF THE INVENTION

According to one aspect of the present invention there is provided a pallet comprising a main body, said main body comprising:

a load deck with a generally planar load surface, said load deck defining a plurality of cavities that are each open on at least one side and said load deck including a plurality of webs extending at least partly between adjacent cavities; and
a plurality of spaced-apart feet protruding from the load deck on a side that is opposite from the load surface, said feet including at least one corner foot in each of four corner regions of the body, the feet serving as supports to keep the load deck elevated and the spaces between the feet providing access for inserting lifting devices underneath the load deck;
wherein at least some of the webs extend at an obtuse angle relative to the load deck and at least some of said webs define apertures between an upper edge and a lower edge of each such web.

The term “elevated” means that the load deck is at a higher elevation than a surface on which the pallet is supported, when in an upright orientation. The construction of a part of the pallet with a plurality of cavities that are open on at least one side, is referred to herein as an “open” structure.

The load deck may have a depth of more than 20 mm, preferably about 36 mm.

The load deck may include flanges extending generally co-planar with the load surface and the flanges may extend from upper edges of the webs of the load deck and define apertures in the load deck, between adjacent webs, in which inserts may be receivable.

The load deck may define an under surface that extends generally parallel to the load surface, between the feet and the load deck may include flanges extending generally co-planar with the under surface. The flanges extend from lower edges of the webs of the load deck and may define apertures in the load deck, between adjacent webs, which could assist in withstanding impact from lifting devices such as forks.

The main body may be made of a fibre reinforced polymeric material and may weigh less than 44 lbs and in one preferred embodiment, the load surface may have dimensions of about 40×48 inches as the pallet may weigh less than 35 lbs.

Each of the feet may be of a hollow construction with tapering walls, such that the feet of one such body are partly receivable inside the feet of another such body in a nesting manner.

The pallet may further include an accessory and one or more of the corner feet may define one or more first attachment formation that is attachable to the accessory of the pallet, such that the accessory extends at least between the attachment formations of the corner feet, e.g. in the form of a cruciform, picture frame, or both.

According to another aspect of the present invention there is provided a pallet comprising a main body, said main body comprising:

a load deck with a generally planar load surface, said load deck defining a plurality of cavities that are each open on at least one side with webs extending at least partly between adjacent cavities; and
a plurality of spaced-apart feet protruding from the load deck on a side that is opposite from the load surface, said feet including at least one corner foot in each of four corner regions of the body, the feet serving as supports to keep the load deck elevated and the spaces between the feet providing access for inserting lifting devices underneath the load deck, each of said feet being of a hollow construction with tapering walls, such that the feet of one such body are partly receivable inside the feet of another such body in a nesting manner;
wherein each foot defines at least one tapered recess extending from the bottom of the foot, towards the load deck.

One or more of the recesses may extend from the bottom of its associated foot to the vicinity of the load deck and the foot may includes a structure, e.g. a structure in the form of a cross member, that is generally aligned with the load deck and that spans the recess.

The body may be dimensioned such that, when an upper such body is nested on top of a lower such a body, the underside of the structures spanning the load recesses of the upper body's feet, rests in abutment on the load surface of the lower body, such that the abutment between said structures of the upper and lower bodies prevent the feet of the upper body from entering the insides of the feet of the lower body beyond a predetermined extent.

The pallet may include nine feet or more, including the four corner feet, and each of the corner feet may have at least one of said recesses that divides the corner foot into at least two pillars. Preferably, each of the nine feet may have such a recess that divides the foot into two or more pillars, such that the pallet has at least eighteen of these pillars and more preferably, each of the nine feet has such a recess that divides the foot into four pillars, such that the pallet has thirty six of these pillars.

According to a further aspect of the present invention there is provided a pallet comprising a main body and an accessory, the main body defining an open load deck with a plurality of cavities that are each open on at least one side, said load deck defining a generally planar load surface and a plurality of spaced-apart feet protruding from the body on a side that is opposite from the load surface, said feet including at least one corner foot in each of four corner regions of the body, the feet serving as supports to keep the load deck elevated and the spaces between the feet providing access for inserting lifting devices underneath the load deck; wherein each of the feet is of a hollow construction with tapering walls, such that the feet of one such body are partly receivable inside the feet of another such body in a nesting manner and wherein each corner foot defines at least one first attachment formation that is attachable to the accessory of the pallet, such that the accessory extends at least between the attachment formations of the corner feet; wherein said accessory is also of an open construction, defining a plurality of cavities that are each open on at least one side.

Feet recesses may be defined in undersides of the feet and accessory protuberances may be defined on the accessory so that the accessory protuberances are receivable in the feet recesses, at least in part.

Each of the accessory protuberances may be of a hollow construction with tapering walls, such that the accessory protuberances of one such accessory are partly receivable inside the accessory protuberances of another such accessory in a nesting manner.

The accessory may include a plurality of second attachment formations that are attachable to the first attachment formations on at least some of the feet and the accessory may define a plurality of accessory recesses in which the feet are receivable, at least in part, with the second attachment formations being disposed inside the accessory recesses, where they are protected against damage.

The accessory may define at least one beam extending between two or more of the feet when the accessory is attached to the feet and the beam may be of an open construction defining a plurality of cavities that are each open on at least one side.

The accessory may define at least one beam extending between two or more of the feet when the accessory is attached to the feet, and the accessory may be dimensioned such that, when an upper such accessory is nested on top of a lower such accessory, the undersides of the upper accessory's beams rest in abutment on the beams of the lower accessory, such that the abutment between the beams of the upper and lower accessories prevent the upper body from entering the accessory recesses of the lower accessory beyond a predetermined extent.

The attachment formations of the pallet may be releasable and may include clip formations and the pallet may define release apertures through which a release element can be inserted to release the clip formations.

The pallet may define a plurality of apertures in a top surface of its load deck, in an underside of its load deck, on upper sides of the beams, and/or on undersides of the beams, in which inserts are receivable. The pallet may include a plurality of these inserts that are receivable in the apertures, each insert being of a slip resistant material.

The pallet may include at least one corner sleeve that can be attached to a foot of the main body by extending around at least part of the foot, the corner sleeve being held captive on the foot between the accessory and the load deck, when the accessory is attached to the first attachment formations.

According to yet another aspect of the present invention there is provided a process for manufacturing a pallet with a load deck, said process including:

closing two parts of a two-part mould to form a mould cavity;
injecting mouldable material into the mould cavity;
allowing the mouldable material to solidify to form the pallet; and
de-moulding the pallet;
wherein the pallet includes a plurality of webs in its load deck, each web being oriented at an obtuse angle relative to the load deck, and wherein the two parts of the two-part mould abut in the vicinity of a neutral axis of at least some of said webs, when the mould is closed, to define an aperture in the web in the vicinity of its neutral axis.

The mouldable material may be a fibre reinforced polymeric material.

According to yet a further aspect of the present invention there is provided a method for providing pallets for the handling of goods, said method comprising:

providing a pallet body defining an open load deck defining a plurality of cavities that are each open on at least one side, said load deck having a generally planar load surface and a plurality of spaced-apart feet protruding from the body on a side that is opposite from the load surface, said feet including at least one corner foot in each of four corner regions of the body, the feet serving as supports to keep the load deck elevated and the spaces between the feet providing access for inserting lifting devices underneath the load deck;
loading goods onto the load deck of the pallet body;
transporting the pallet body with the goods loaded on top of it; and
attaching an accessory to the feet of the pallet body such that the accessory extends at least between the four corner feet in a manner such that the accessory is spaced from the load deck.

The load deck of the pallet body may include a plurality of webs extending at least partly between adjacent cavities, at least some of the webs extending at an obtuse angle relative to the load deck and at least some of these webs defining apertures between an upper edge and a lower edge of each such web.

The method may include supporting the pallet on opposing sides in a racking system, after attaching the accessory to the feet of the pallet.

The method may include off-loading the goods before attaching the accessory to the feet of the pallet body.

The method may include an additional step of releasing the attachment of the accessory from the feet of the pallet body and may further include re-attaching the accessory to the feet of the pallet body.

Each of the pallet body's feet may be of a hollow construction with tapering walls and the method may include the step of transporting a plurality of the pallet bodies in a nesting arrangement, with the feet of one such body partly received inside the feet of another such body in a nesting manner, before loading the pallet body with goods.

Each of the pallet body's feet may be of a hollow construction with tapering walls and the method may include the step of transporting a plurality of the pallet bodies in a nesting arrangement, with the feet of one such body partly received inside the feet of another such body in a nesting manner, after the goods have been off-loaded and before the accessories are attached to the main bodies.

The goods to be transported on the pallet body may include a polymer and the method may include manufacturing the pallet body at the location from where the goods are to be transported, using polymer supplied by a sender seeking to transport the polymer.

The method may include repeatedly using the pallet after attaching the accessory to the feet of the pallet body and the method may include renting out the pallet as part of a pool of pallets, after attaching the accessory to the main body.

The method may include removably attaching one or more deck extension accessory to one or more edges of the load deck of the pallet body. In one embodiment, the load deck has a size of about 40×48 inches and the load surface of the pallet is increased to 52×44 inches with the addition of the deck extension accessory.

### BRIEF DESCRIPTION OF THE DRAWINGS

For a better understanding of the present invention, and to show how the same may be carried into effect, the invention will now be described by way of non-limiting example, with reference to the accompanying drawings in which:

FIG. 1A is a three-dimensional view of a pallet in accordance with the present invention, from above;

FIG. 1B is a three-dimensional view of the pallet of FIG. 1A, from below;

FIG. 1C is a top plan view of the pallet of FIG. 1A;

FIG. 1D is a side view of the pallet of FIG. 1A:

FIG. 2 is a three-dimensional view of a main body of the pallet of FIG. 1A;

FIG. 3 is a detail view of a corner of the main body of FIG. 2;

FIG. 4 is a three-dimensional view of a plurality of the bodies of FIG. 2, stacked in a nesting arrangement;

FIG. 5 is a three-dimensional view of an accessory of the pallet of FIG. 1A;

FIG. 6 is a detail view of a corner of the accessory of FIG. 5;

FIG. 7 is a three-dimensional view of a plurality of the accessories of FIG. 5, stacked in a nesting arrangement;

FIGS. 8A and 8B are sectional views through part of the pallet of FIG. 1A, taken at VIII-VIII, showing the engagement and attachment between the main body of FIG. 2 and the accessory of FIG. 5. In FIG. 8A, the parts are shown shortly before the engagement and in FIG. 8B they are shown in engagement;

FIGS. 9A and 9B are sectional views through part of the pallet of FIG. 1A, taken at IX-IX, showing the engagement and attachment between the main body of FIG. 2 and the accessory of FIG. 5. In FIG. 9A, the parts are shown shortly before the engagement and in FIG. 9B they are shown in engagement;

FIG. 10 is a sectional view through part of a deck of the pallet of FIG. 1A, showing two inserts received in recesses of the deck;

FIG. 11 is a sectional view of a first embodiment of an identification tag being fitted in a foot of the pallet of FIG. 1A;

FIGS. 12A and 12 B are an exploded side view and a sectional side view of a second embodiment of an identification tag being fitted in a foot of the main body of the pallet of FIG. 1A;

FIG. 13 is a plan view of an alternative embodiment of a corner of the accessory of the pallet of FIG. 1A;

FIGS. 14A and 14B are sectional side views at XIV-XIV of the accessory of FIG. 13, showing an exploded view and an assembly, respectively, of an identification tag being fitted in the corner of the accessory;

FIG. 15 is a three-dimensional view of a deck extension accessory for use with the pallet of FIG. 1A;

FIGS. 16A and 16B are detail sectional views of parts of the main body of the pallet of FIG. 1A, fitted with the deck extension accessory of FIG. 15;

FIG. 17 is a three-dimensional view of an edge insert for use with the pallet of FIG. 1A;

FIG. 18 is a detail sectional view of part of the main body of the pallet of FIG. 1A, fitted with the edge insert of FIG. 17:

FIG. 19 is a three dimensional view of a corner sleeve of the pallet of FIG. 1A; and

FIGS. 20A and 20B are detail sectional views through part of the load deck of the pallet of FIG. 1A, shown in FIG. 20A inside a two-part mould and shown in FIG. 20B after de-moulding.

### DETAILED DESCRIPTION OF THE DRAWINGS

Referring to the drawings, a pallet in accordance with the present invention is generally indicated by reference numeral 10, whereas a main body of the pallet is generally indicated by reference numeral 12 and a bottom accessory of the pallet is generally indicated by reference numeral 14.

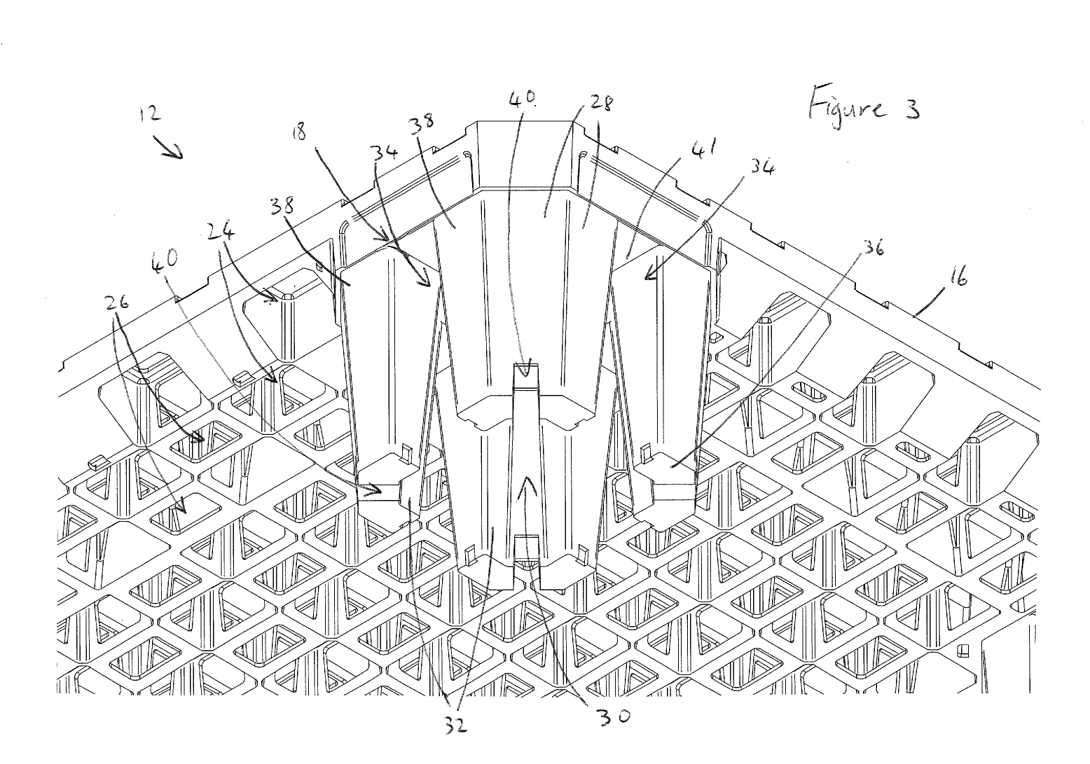

Referring to FIGS. 2 to 4, the main body 12 can be made of any suitably light, strong and durable material, but is preferably a unitary moulding of reinforced polymeric material and it includes a load deck 16 and nine feet 18 protruding from the underside of the load deck. The top of the load deck 16 defines a generally planar load surface 20 and the underside of the deck defines an under-surface 22 that is continuous between the feet 18. The feet 18 are disposed at the corners, mid-way along the edges and in the centre of the load deck 16.

The deck 16 is made up of a continuous lattice of webs and flanges that define an array of cube-like cavities 24, each defining a rectangular recess or aperture 26 that is surrounded by a rectangular flange or frame. The alternate cavities 24 have apertures 26 that are disposed in the load surface 20 and in the under-surface 22 of the load deck 16. The under-surface 22 is bevelled towards the load surface, around the periphery of the load deck 16. The load deck 16 has a depth that is more than 20 mm and that is preferably about 36 mm.

Each foot 18 is hollow and has tapering outer walls 28 that give it a generally octagonal profile. Each foot defines a foot recess 30 in its centre, surrounded by tapered inner walls 32. Further, each foot 18 has four recesses 34 extending upwards from its bottom 36, so that the foot has four angled pillars 38, each defined between the inner walls 32, outer walls 28 and two recesses 34. At the bottom of each pillar 38, there is a first attachment formation in the form of a rectangular aperture 40.

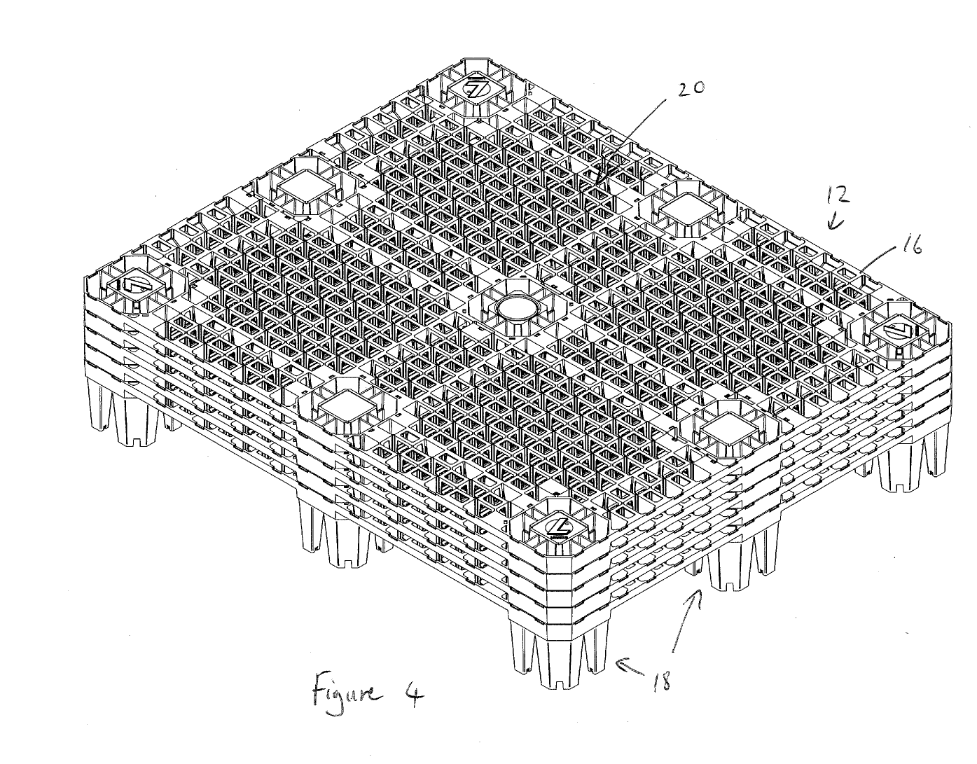

The hollow construction of each foot 18, together with the angled structure of its inner and outer walls 32,28 allows the feet of one body 12 to be received in a nesting manner inside the hollow insides of the feet of another body 12 below it, when the bodies are stacked on top of one another, as shown in FIG. 4. In the nested condition, the underside 22 of the load deck 16 of the body 12 above rests against the load surface 20 of the body below it, and this abutment of the load decks prevents the feet 18 of the upper body from entering the insides of the feet of the lower body too far and thus prevents the feet from getting stuck in the nesting arrangement as result of a taper lock.

As can be seen in FIGS. 8A and 8B, the body 12 includes a cross member 41 that is generally aligned with the load deck and spans the foot recess 30, between the inner walls 32 of the foot 18. The cross member 41 serves to carry tensile loads on the inside of the foot 18, to resist deformation of the foot in racking or stacking with a heavy load on the pallet. In some preferred embodiments, the cross member 41 has a deeper profile than the load deck 16, but with the top of the cross member aligned with the load surface 20, this means that the bottom of the cross member extends lower than the under surface 22 and as a result, when the main bodies 12 are nested, the bottom of the cross member of the upper body 12 rests on the top of the cross member of the lower body 12 and this abutment of the cross members 41 prevents the pillars 18 of the bodies 12 from entering too deeply into each other.

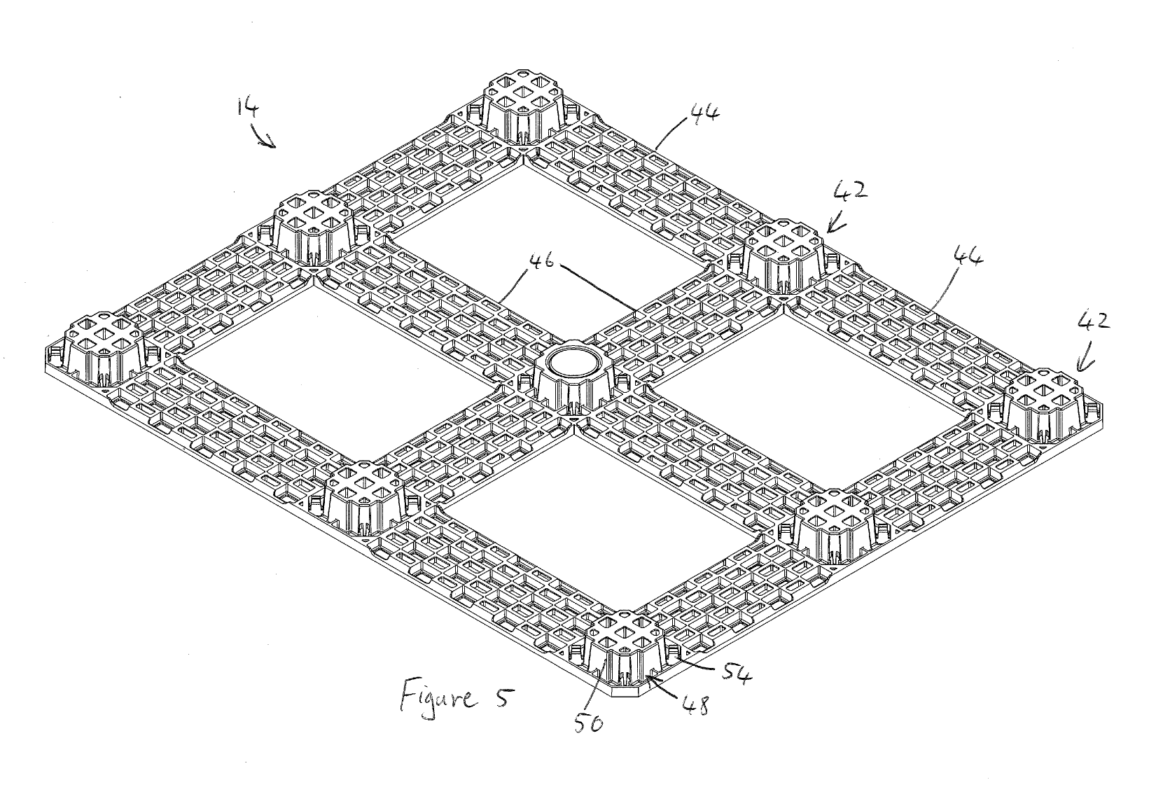

Referring to FIGS. 5 to 7, the bottom accessory 14 can also be made of any suitably light, strong and durable material, but is preferably a unitary moulding of reinforced polymeric material. It is generally rectangular and has nine “second” attachment formations 42, disposed at its corners, midway along its sides and at its centre. The size of the bottom accessory 14 corresponds to that of the load deck 16 and the positions of the attachment formations 42 correspond with those of the feet 18.

The bottom accessory 14 includes outer beams 44 that extend between attachment formations 42 disposed at the corners and midway along the sides of the accessory, to form a rectangular structure (referred to in the art as a “picture frame”), as well as inner beams 46 that extend from the central attachment formation to each of the attachment formations midway along the sides, to form a cross structure (referred to in the art as a “cruciform”). The construction of each of the beams 44,46 is very similar to that of the load deck 16, with a continuous lattice of webs and flanges defining cavities 24, with apertures 26 on the top and bottom of each beam and with a bevelled edge. However, the depth of the beams 44,46 is substantially less than that of the load deck 16, making the load deck better suited to bear bending loads, but the beams suited to bear tensile loads.

Each of the attachment formations 42 defines a generally octagonal accessory recess 48 and an upstanding hollow accessory protuberance 50 in the centre of the recess. The walls of the protuberance 50 are angled and define steps 52, so that each corner region of the recess 48 can receive the lower end of a pillar 38 of its corresponding foot 18 in a snug manner between the walls of the recess 48 and protuberance 50 and the steps 52.

At each corner of each recess 48, a second attachment formation is provided in the form of a pair of resilient clips 54 with barbs facing outwards. In the illustrated embodiment, the upper ends of the clips 54 protrude above the upper surfaces of the adjacent outer beams 44, but in some preferred embodiments, the depths of the beams and the lengths of the clips are selected so that the clips do not protrude above the upper surfaces of the beams 44,46 at all.

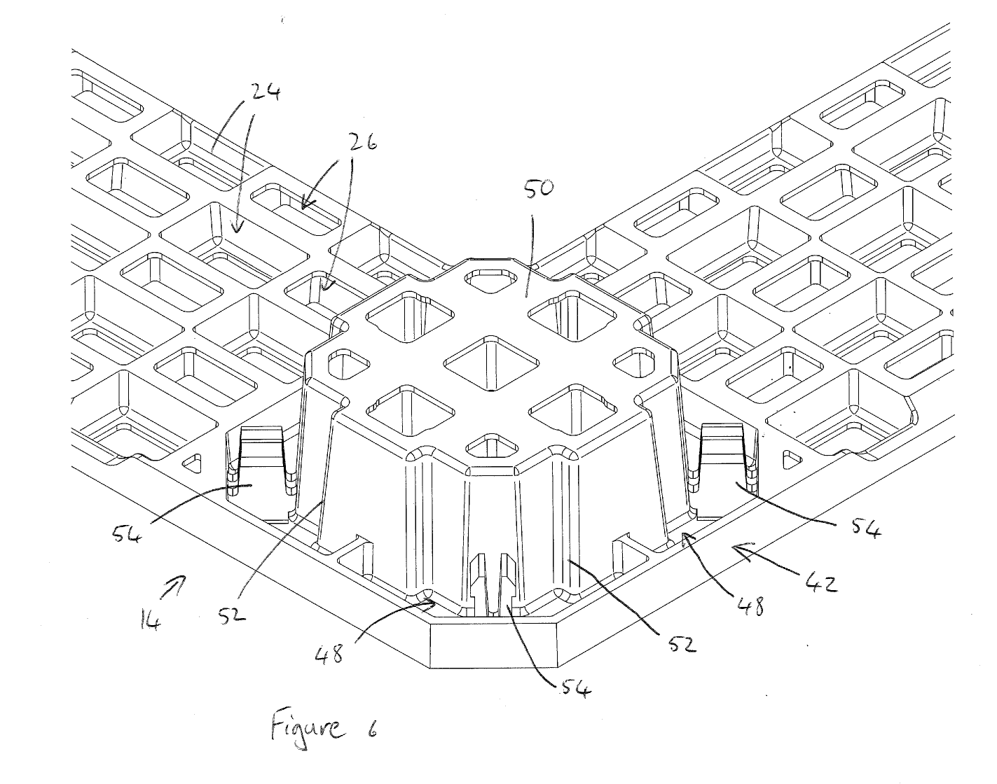

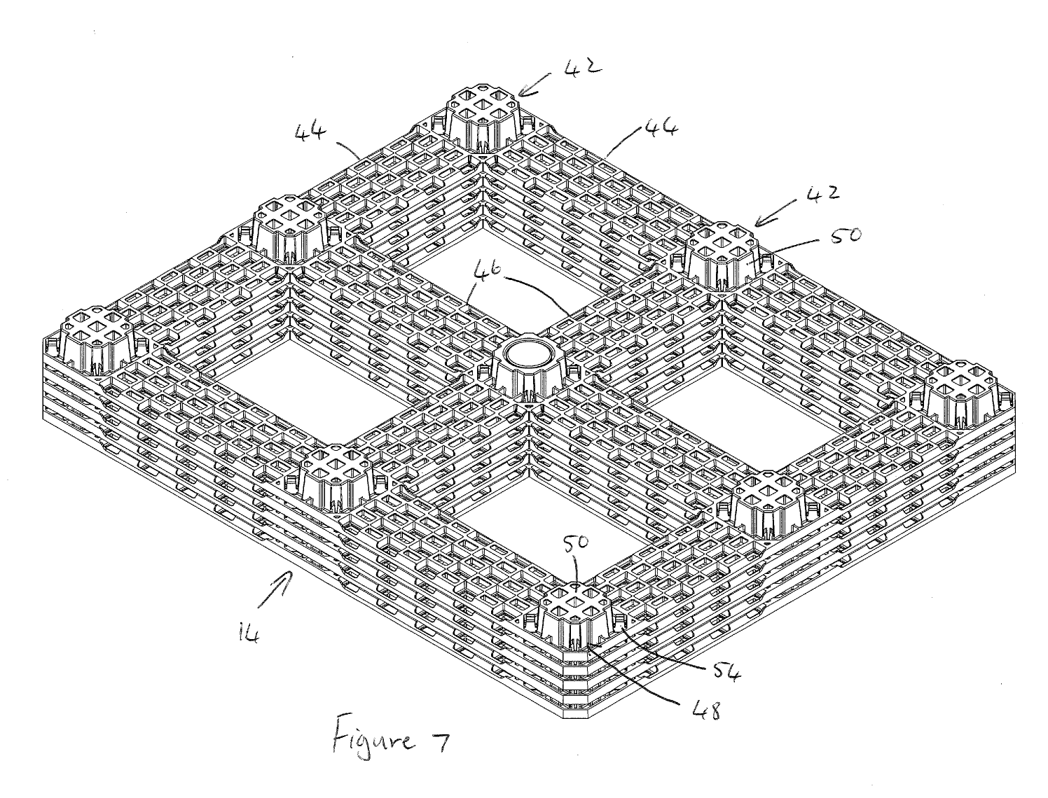

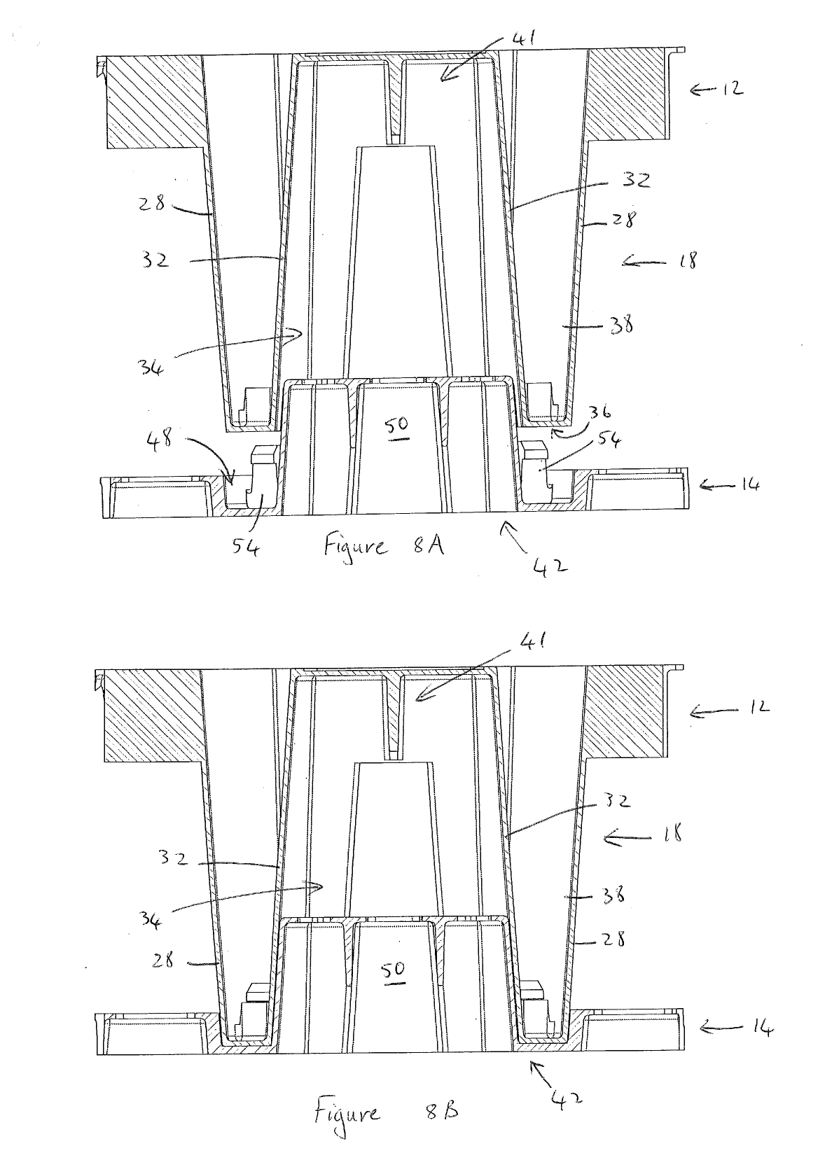

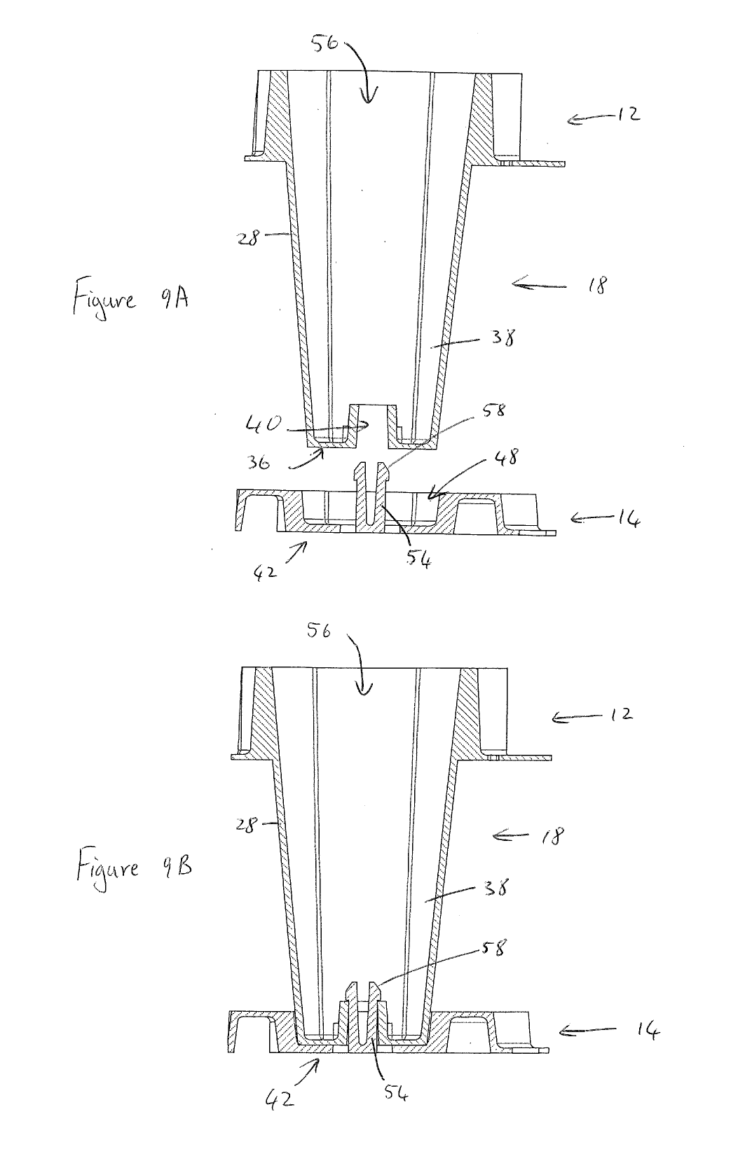

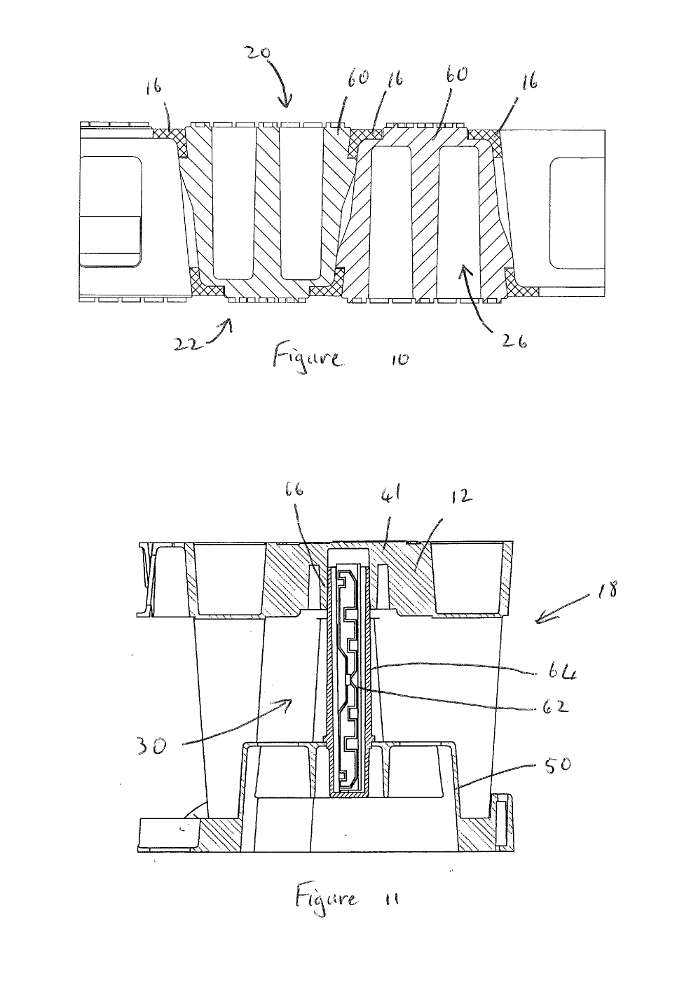

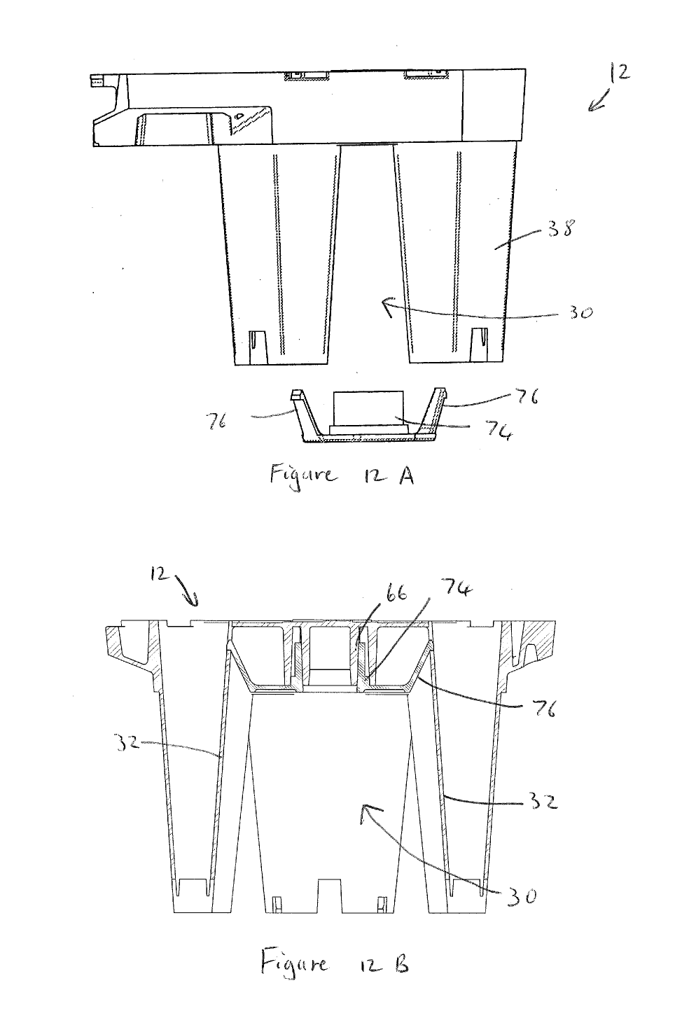

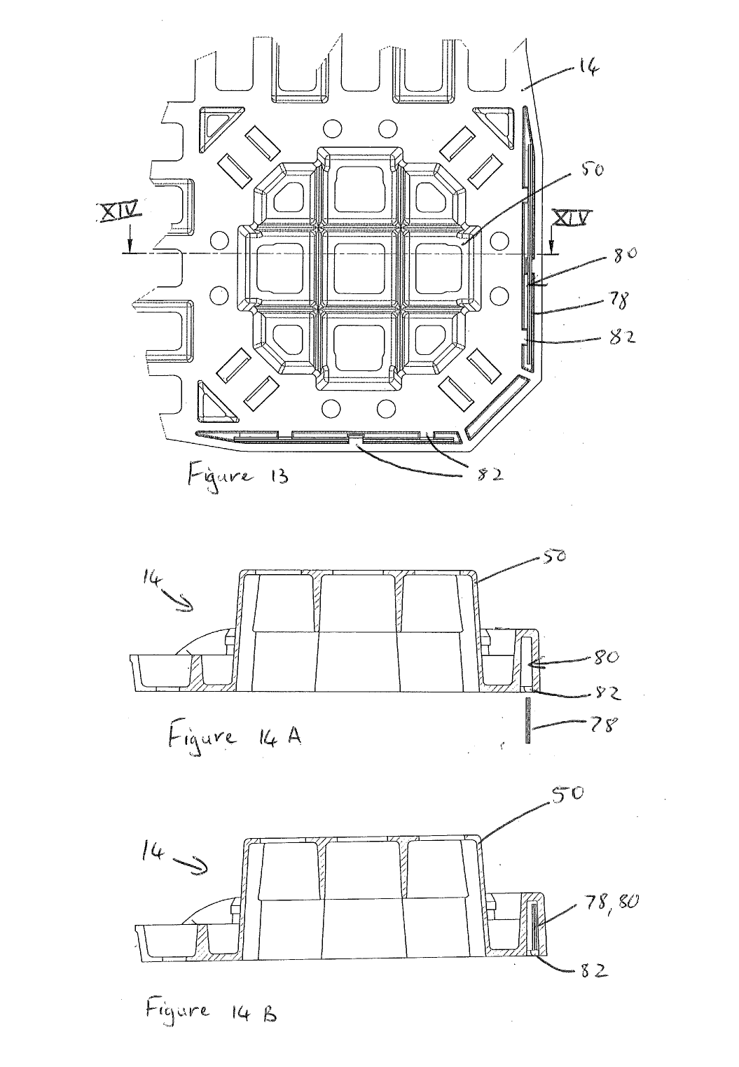

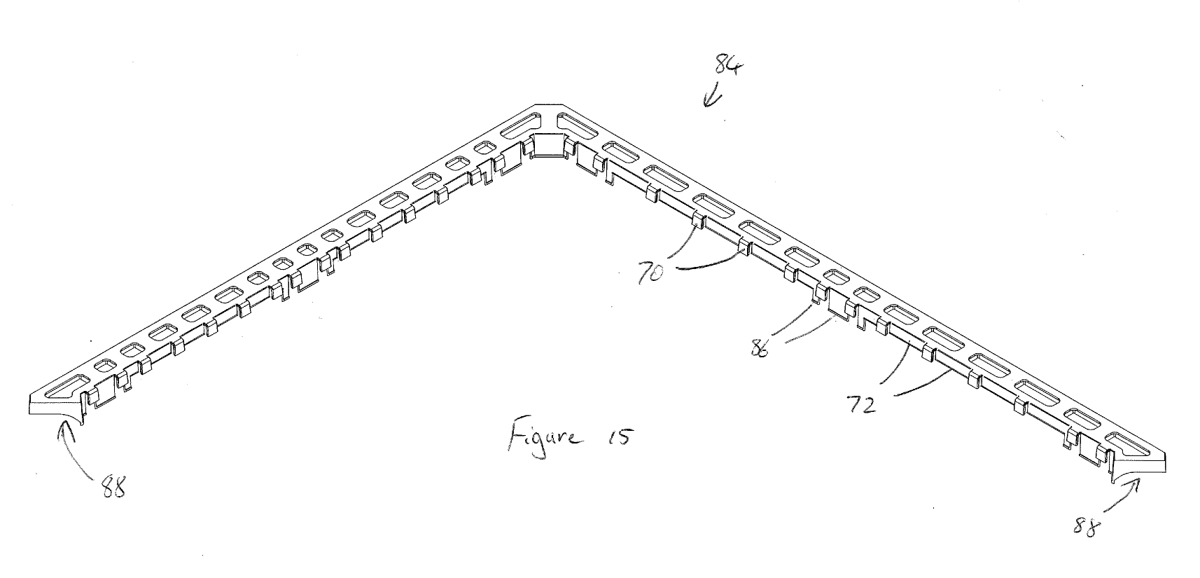

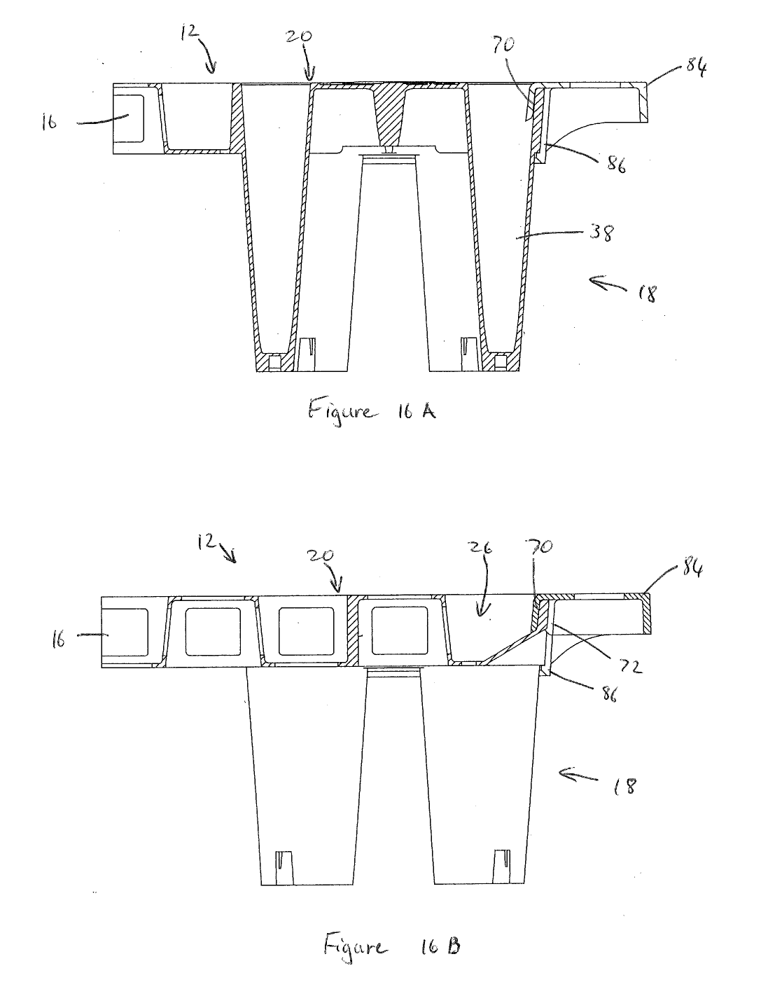

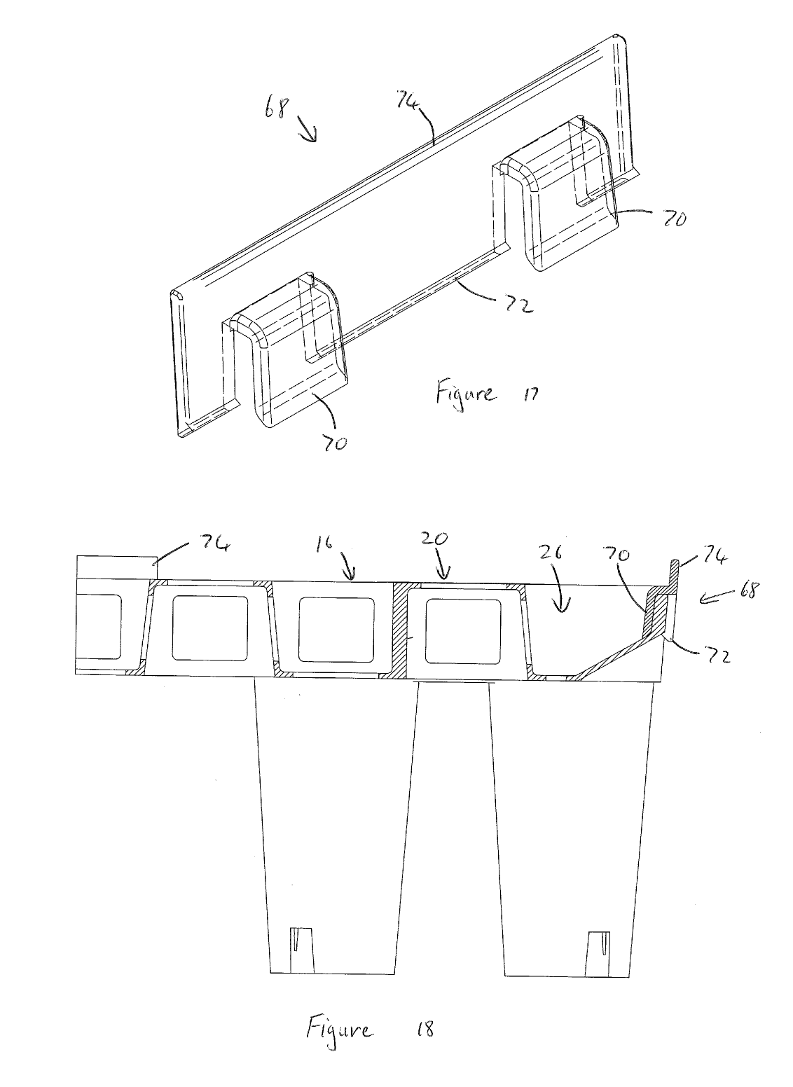

Like in the case of the body 12, the bottom accessory 14 can be stacked to form a nested stack of accessories as shown in FIG. 7. The hollow construction of the protuberance 50 and its tapering walls allows the protuberance of a lower one of the accessories to be received inside the protuberance of an accessory immediately above it, in a nesting arrangement. Like in the case of the body 12, the bottom accessory 14 is shaped and configured such that the undersides of its beams 44,46 rest on top of the upper surfaces of the beams of the accessory below it, when nested, without the protuberance 50 of the lower accessory extending too far into the protuberance of the top accessory. In some embodiments, part of the upper bottom accessory 14 may extend into the recess 48 of the lower bottom accessory, when nested, but the extent to which this can happen is limited by the abutment of the beams 44,46 to prevent any part of the upper accessory from damaging the clips 54.

Referring to the lattice structure of the load deck 16 and beams 44,46: The load deck 16 has an even thickness throughout and has a uniform support capacity and the load surface 20 and under surface 22 are uniformly the same strength right through the deck, which allows for better handling of uneven loads on top of the deck. Further, the deck 16 is easily washable as there are no closed holes from the top or bottom through the top or bottom decks (apart from the feet 18). This feature also allows air or water to flow easily through the whole pallet 10, which allows much better cooling and temperature control with reduced energy requirements when transporting the pallets in trucks or transport containers (e.g. in a “cold chain”). The improved control of air flow throughout the pallet 10 and fruit and other perishable products packed on the load deck 16, allows the pallets and their loads to be cooled more effectively and efficiently. There is thus also less wasted product because quicker ripening and other high temperature problems can be avoided. Further, better cooling and/or temperature control during transport of fresh produce on the pallet 10 allows longer shelve lives of the produce, when sold in retail. The effective cooling characteristics of the pallet 10 allows for direct containerisation, eliminating the requirements for pre-cooling in cold storage before shipment. Fruit can now be shipped immediately and reach the destined markets earlier and ensure a longer shelf life.

The construction of the pallet 10 from polymeric (plastic) material also has the advantage of inhibiting or preventing mould or bacteria formation on the pallet, as is often found with wooden pallets, because of wood impurities. The plastic material can also be made resistant to bacteria, mould, etc., which again contributes to longer shelf life of produce transported on the pallet 10. Moisture in wood contributes to condensation in closed containers and causes and promotes product damage, fungus, mould and mildew growth as well as metal oxidation. The use of polymeric material also eliminates the presence of any additional moisture source in the container normally associates with un-dried or insufficiently dried timber.

The uniform structure of the deck 16 also prevents fork lift blades from entering the deck from below (through human error) at any ribs, planks not properly joined to the pallet, etc.—as in the case of prior art pallets.

The body 12 and bottom accessory 14 are formed in separate moulds where the molten polymer enters the mould cavities through the middle foot 18 or middle attachment formation 42, as the case may be, through a large gate. The purpose of the large gate is to keep the fibres in the polymer long to achieve good mechanical properties for the weight of the polymer matrix. The polymer matrix can include glass fibre and other additives such as UV resistors colorants, additives for compatabilizing different polymers and fire retardants that assist in compliance with the UL 2335 specifications. Even anti bacterial additives can be provided should it be required. There are many other additives that could be used in the formulation should there be a requirement. By injecting the polymer through a single injection point, the formation of weld lines can be controlled and there is the freedom to cool the mould in such a way that, even if weld lines are formed, they are strong because the temperature of the polymer on opposing sides of the welds are within 5% of one each other. The mould can also be designed so that the polymer flows into the mould in such a way that the welds meet mainly in the feet of the pallet.

The material properties of long glass fibre with polyolefin's in a matrix give lower creep and thermal expansion values that are even better than aluminium and magnesium and are very close to thermal expansion values of steel, but the glass fibre must be longer than 10 mm if used in polypropylene and more than 20% by weight of glass fibre is required. The glass fibres are inert to fire and costly fire retardant additives only need to be provided for the polymer portion of the material. The material as described herein is thermally stable in temperatures ranging between −20 degrees C. and 40 degrees C.

Referring to FIGS. 8 and 9, when the body 12 and bottom accessory 14 are to be attached together, each foot 18 is attached to its corresponding attachment formation 42 and at the same time:
the lower ends of the foot's pillars 38 are received inside the recess 48 of the attachment formation 42;
each foot's protuberance 50 is received inside the recess 30 of the attachment formation (in the illustrated embodiment, the protuberance 50 extends about one third into the depth/height of the recess 30);
the outer walls 28 of the feet 18 abut outer walls of the recess 48;
outer walls of the protuberance 50 abut the inner walls 32 of the foot; and
each pair of the clips 54 engage the aperture 40 of its corresponding pillar 38 in a clipping manner.

The engagement between the foot 18 and its attachment formation 42 can bear downwards compressive loads because the bottoms 36 of the pillars 38 simply press against the bottom of the recess 48. The engagement can also bear shear loading, i.e. side-to-side forces acting on either the body 12 or the bottom accessory 14, by the walls of the pillars 38 pressing against the walls from the recess 48 and the walls of the protuberance 50 pressing against the walls of the recess 30. Accordingly, the only forces that the engagement of the clips 54 in the apertures 40, need to bear, are vertical forces that seek to pull the body and the accessory apart. These forces are borne in the clips 54 as tensile forces and the clips are thus not exposed to significant shear or bending forces during normal use and are only exposed to mild bending forces during engagement or disengagement of the body 12 and the bottom accessory 14.

The hollow inside of each pillar 38 forms a release aperture 56 in which an appropriately shaped device can be inserted from above, to press against bevelled edges 58 of the clips 54, to press the clips closer together and thus release the engagement of the clips with the aperture 40. The bottom accessory 14 can thus be removed from the body 12, if required, and can be re-fitted to the same or another body. This allows inter-changeability of the bodies 12 and accessories 14 to allow easy maintenance of the pallet 10 by replacing a damaged body 12 or bottom accessory 14.

The outside dimensions of the load deck 16 and of the bottom accessory 14 are about the same and this differs from other pallets with nestable upper parts. Further, the beams 44,46 of the bottom accessory 14 covers more than 55% and typically 65% of the area of the underside of the pallet 10.

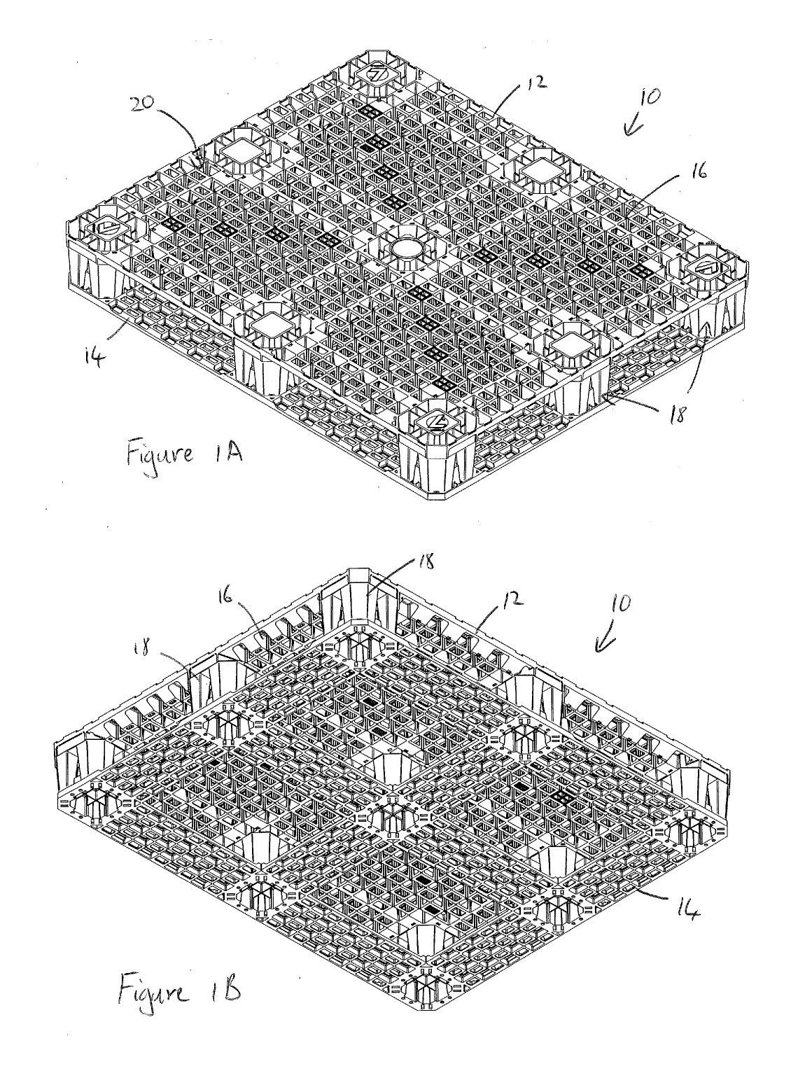

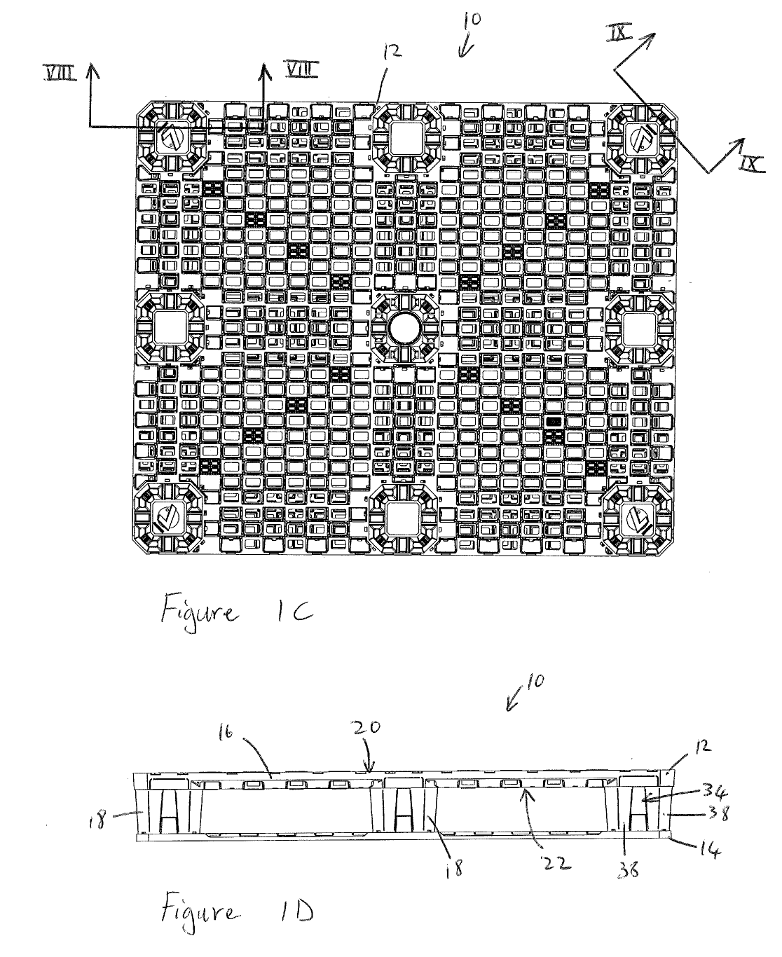

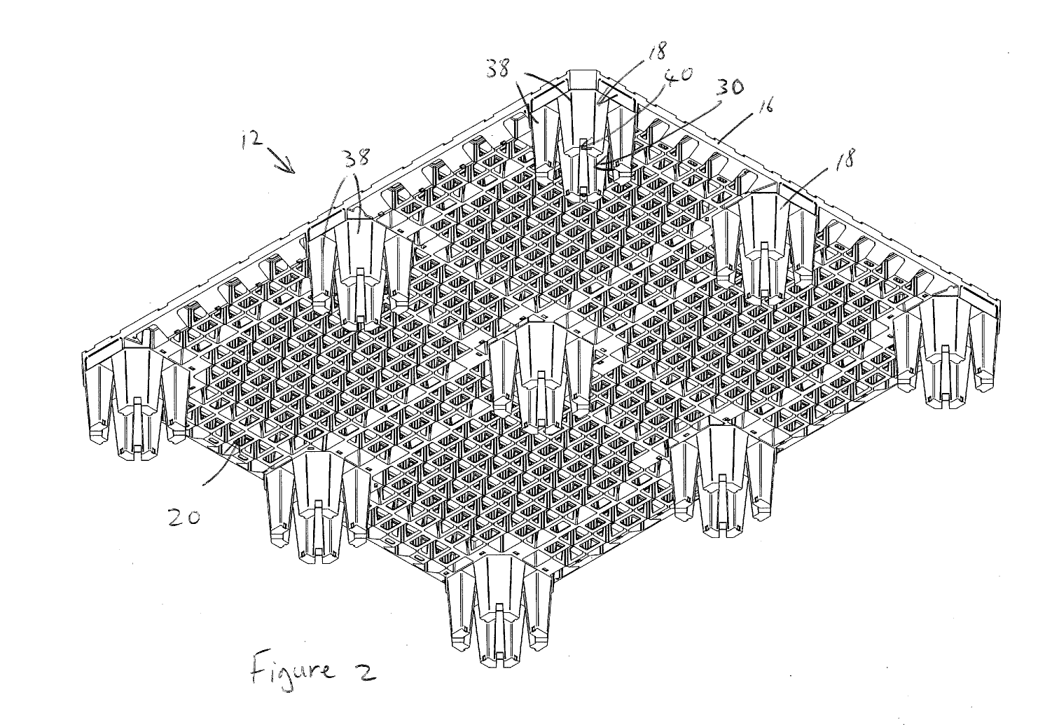

Referring to FIGS. 1 to 9, in use, the main body 12 can serve the purpose of a pallet that need not be stacked or racked and that need not bear heavy duty. Further, the body 12 on its own is quite light in weight and can be nested. The weight of the main body 12 is less than 12 kg and is significantly less than any existing nesting pallet that can do the same duty as that of a one-way wooden pallet. Yet, despite its low weight, the body 12 is capable of carrying a dynamic load of 1.5 metric tonne or a static load of up to 4 metric tonnes or more. The body 12 can thus be used on its own to receive a load on its load deck and can be used to transport that load, with the advantages of the light weight of the body. Further, the body 12 can be transported in a cost-effective manner to the location where it is to be loaded, by nesting the bodies together during transportation and thus saving space.

In some cases, the benefits of using the body 12 to transport loads are even greater, if they can be produced at the location from where products are to be transported. In particular, in the chemical industry, where very large quantities of polymer material products need to be transported on pallets from the polymer suppliers to their customers, polymers from the suppliers can be used to manufacture the bodies 12 at the site from where the polymer material products are to be transported. Similarly, in the cases of manufacturers of suitable reinforcing fibres (e.g. glass fibres), glass fibres from the manufacturers can be used to manufacture the bodies 12.

The cost of manufacturing the bodies 12 at the site from where products are to be despatched or manufacturing the bodies elsewhere and transporting them to the site, is much lower than the cost of current practices of transporting conventional wooden pallets to the site, in complete form.

Further, there are savings in transport costs because the low weight of the body 12 allows more product to be transported in a total load, without increasing the weight of the load. E.g. one extra 25 kg bag of polymer product can be carried on every body 12 (weighing less than 12 kg), which is capable of serving the same function as a conventional wooden pallet weighing about 42 kg. By adding the extra bags of polymer to each pallet load, up to 800 kg of additional product can be transported in each payload, without additional payload costs. When the bodies are transported without load (whether to depots, distributors, retailers, washing depots, or the like), at least half the transport cost is saved because more than twice the number of bodies 12 can be transported (in the nested configuration described above) for the same volume and weight of conventional wooden pallets (assembled with nails). These transport savings reduce the energy required for transport, which results in substantial benefits in reducing carbon emissions. In addition, the pallet 10 holds the environmental advantages that it does not lead to deforestation as in the case of wooden pallets and the materials of which the pallet 10 are made are recyclable. The sustainability and environmental benefits are very substantial and allow the pallets 10 to compete on an economic basis with conventional wooden pallets.

Once the bodies 12 are available at the site from where goods are to be transported, they are loaded by placing the goods on the load surfaces 20 and the goods and pallets are transported to their destinations, where the goods are off-loaded. Under normal trading conditions, a pallet used to transport the goods up to this point would either have been a one-way wooden pallet that would be discarded, or it would have been a durable, heavy duty pallet that can be re-used, but that would have had the disadvantages of costly transport up to this stage (because of the weight and non-nestability of the pallets). However, the bodies 12 of the present invention can be collected after use and can be transported cost-effectively because of their low weight and nesting ability and can be re-used.

To the inventor's knowledge: No existing wooden pallet used in transporting products has the ability for its feet to nest. There are however plastic pallets that can nest but no existing nesting pallet can carry more than a 2800 lbs dynamic weight load. No existing plastic pallet that can compete with the pallet 10 on performance (i.e. in terms of static and dynamic loading capacity, racking with bending, etc.) has the ability for its feet to nest. No existing nesting pallet can simultaneously meet the requirements of “one man lift less than 35 lbs” (i.e. the “OSHA requirement”), a racking weight in a 40×48 inch pallet with a height of 5.75 inches, of more than 2800 lbs with safety of 50% and bending less than 20 mm. However, the pallet 10 separated into the main body 12 and bottom accessory 14 has nesting capability in so far as the main bodies are nestable and the bottom accessories are nestable. Pallet 10 meets all these requirements.

The pallet 10's dimensions could be changed to achieve all the standardised pallet configurations of “CP1” to “CP9” for the chemical industry as well as the USA chemical standards of 40×48 inch×5.75 inch high, 52×42 inch and 45×45 inch as well as the printing pallet sizes of 44×44 inch, 48×42 inch, and 42×42 inch. To the inventor's knowledge, none of the presently available pallets that satisfy these requirements are nestable. The combination of nestability with the load bearing and racking requirements is a major breakthrough in the worldwide pallet industry. This was achieved through the material formulation and the design of the pallet 10. When the feet 18 are attached to their corresponding receiving formations 42, the complete pallet 10 becomes a structural member with very low weight i.e. less than 44 lbs.

The fact that the pallet 10 is made in two parts (the body 12 and bottom accessory 14) and is thus not moulded in a single shot mould (as in cases where the top deck and the bottom deck of a pallet are moulded together in a single shot), there is no need to slide cores from the sides of the mould and the moulds are much less complex. A single-shot pallet where the complete pallet is made with the top and bottom deck together in a unitary moulding can never nest to save transport costs. Such a single-shot pallet also necessarily has more weight because it needs to be shaped to allow for the moulds to come away from the ribs in a taper design, but the design of the pallet 10 does not require a taper in the rib structure.

The spaces between the feet 18 serve as access for the forks of lifting apparatus such as fork-lift trucks, to lift the bodies 12 (or pallets 10), with or without a load.

When the bodies 12 are to be re-used, they can be used as described above, or they can be used in the form of a heavy duty pallet 10 which is capable of stacking, racking and heavy loads, by attaching the bottom accessory 14 to the body 12 as described above. The bottom accessory 14 allows the pallet 10 to be stacked because the beams 44,46 can distribute the weight of the pallet 10 (and its load) on the load of a pallet below it. The bottom accessory 14 allows the pallet 10 to be racked because the beams 44,46 can bear tensile loads, thus increasing the stiffness of the pallet substantially, against bending or deflecting under its load. The bottom accessory 14 also enhances the strength of the pallet 10 generally by providing a pallet that is stiffer than the body 12 on its own.

In this formation the complete pallet 10 will preferably weigh less than 35 lbs or 16 kg and still satisfy the OSHA requirements in the USA for a one man lift, have a dynamic load capacity of up to 1.5 metric tonne or more, have a static load capacity of up to 12 metric tonnes or more and be able to rack up to 1300 kg or more with deflection of 20 mm or less. The inventor believes that these properties can be achieved at room temperatures of about 23 degrees C., but also in temperatures as low as −20 degrees C. and in temperatures as high as 40 degrees C., or more.

The pallet 10 can thus be used for many purposes once the bottom accessory 14 has been attached to the body 12, but depending on the intended use of the pallet, it may be preferable to release the attachment of the accessory to the body, e.g. to transport the bodies and bottom accessories separately in nested (more space efficient) stacks, it may be preferable to use the bodies 12 on their own again, or the like.

The invention holds the advantage that the provision of the bottom accessory 14 that can be releasably attached to the body 12, allows the body to be converted from a light duty (“one-way” or “export”) pallet to a heavy duty (“return” or “pool”) pallet, as required, while the invention also holds the advantages of economy of space and weight when the body 12 and bottom accessory 14 are separate. The design of the pallet 10 further gives it the strength required for most heavy duty applications, with a significantly lower cost and weight of the pallet.

As can best be seen in FIG. 1D, the recesses 34 between the pillars 38 of the feet 18 form apertures, when the feet 18 are attached to the attachment formations 42. The design of the feet 18 with these apertures formed by the recesses 34, saves weight and adds structural strength to the pallet 10.

Referring to FIG. 10, each of the many recesses or apertures 26 can receive an insert 60 (referred to as a “grommet” in the art) of a slip resistant material. The plurality of apertures 26 allows the number and positions of grommets 60 to be selected to suit the needs for particular uses of the pallet 10. The number and positions of the grommets 60 can thus be selected for the load surface 20 (to prevent loads from slipping on the pallet), in the undersides of the beams 44,46 (to prevent the pallets from slipping around) as well as in the underside 22 of the load deck 16 and/or the top of the beams 44,46 (to prevent unwanted slippage of the pallet relative to the forks of a lifting device).

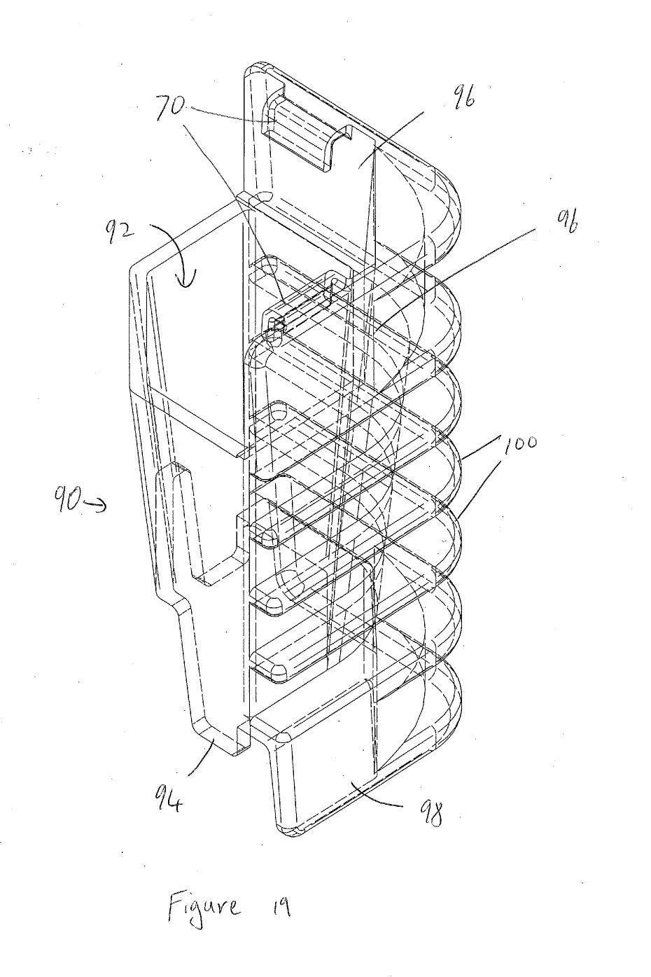

Referring to FIGS. 17 and 18, edge inserts 68 can be fitted to the load deck 16 by inserting a hook formation 70 into an aperture 26 of the load deck 16, at an edge of the deck and gripping the deck with a clip 72. When the edge insert 68 is received in this manner, it provides an upstanding ridge 74 that protrudes above the load surface 20 to assist in preventing loads from sliding on the load surface 20 or sliding off the load deck 16.

Referring to FIGS. 11 to 14, the pallet 10 can be fitted with identification tags, such as RFID tags, to assist in pallet identification.

In the embodiment shown in FIG. 11, a first embodiment of an RFID tag 62 is inside a protective cylindrical housing 64 that is fitted to the body 12 by inserting it from below into the foot recess 30 and receiving an upper end of the housing in a complementary formation 66 formed on the cross member 41. The lower end of the housing 64 is received in a complementary aperture in the top of the accessory protuberance 50 and the housing and tag 62 are kept captive inside the foot 18, where they are protected by the surrounding structure of the foot. The tag 62 can be removed easily, when the body 12 and bottom accessory 14 are separated as described above.

In the embodiment shown in FIGS. 12A and 12 B, a second embodiment of an RFID tag is a strip that is adhesively attached to a carrier 74 that can be inserted into the recess 30 and fitted onto the complementary formation 66, to be held in place by flexible clips 76 that engage apertures defined in the inner walls 32 of the pillars 38. The RFID tags are thus fitted securely, deep inside the recesses 30, where they are protected against damage. Further, these tags allow the main body 12 to be identified, with or without the bottom accessory 14.

In the embodiment shown in FIGS. 13, 14A and 14B, a third embodiment of an RFID is a strip that is sealed between two strips of plastic material, to form a strip-shaped RFID device 78. Elongate slots 80 are defined inside the bottom accessory 14 in which the devices 78 can be received. Each slot 80 has retaining barbs 82 on opposing sides of the slot, so that the device 78 can be flexed to fit between the barbs and be inserted into the slot 80, after which the device straightens once inside the slot, so that it is held captive by the barbs. The device 78 allows the bottom accessory 14 to be identified, with or without a main body of the pallet. The position of the device 78, close to the underside of the bottom accessory 14 reduces the risk of impact from the forks of a lift truck, because the forks are practically always angled (to prevent pallets and/or loads slipping forward when driving), so that the forks ends are above the ground and thus higher than the device 78.

The separate RFID tags that can be fitted on the main body 12 (shown in FIGS. 12A and 12B), bottom accessory 14 (shown in FIGS. 13 and 14) and/or the assembled pallet 10 including a main body and accessory (shown in FIG. 11), allows the pallet 10 and/or its component parts 12,14 to be tracked together or separately.

Referring to FIGS. 15 and 16, a deck extension accessory 84 is provided that includes hook formations 70 and clips 72, similar to those of the edge insert 68 shown in FIGS. 17 and 18, that can grip the edge of the load deck 16. In addition, the accessory 84 has longer clips 86 that can grip the edge of the load deck 16 in areas where it is deeper, e.g. in the regions of the feet 18 (with the hook formations received in the insides of the pillars 38, in addition to the recesses 26).

The accessory 84 is configured to extend along two perpendicular edges of the load deck 16 and has an upper surface that is generally aligned with the load surface 20 of the load deck, when the accessory has been fitted. Accordingly, when the accessory is fitted, it engages the edge of the load deck 16 (with the hooks 70 and clips 72,86) and extends the size of the load surface 20. The ends 88 of the accessory 84 are bevelled, so that when two accessories are fitted to the body 12, they increase the size of the load surface 20 at all four edges of the load deck 16.

The effect of fitting the accessories 84 is to increase the load surface of the pallet body 12 and the accessories 84 can be removed again, which means that with the use of the accessories, it is possible to alter the size of the load surface, to suit loading needs.

As mentioned above, in some industries, certain pallet sizes are preferred to optimise available space, e.g. in the chemical industry, a 1.3 m×1.1 m pallet is preferred for one-way shipment of products (or 52×44 inch in the USA), because it allows shipping containers and vehicles to be loaded more optimally. However, in other industries, e.g. the transport of fast-moving consumer goods, other sizes (e.g. a 1.2 m×1.0 m pallet, or 48×40 inches in the USA) may be the standard that fits in warehousing systems (which could require racking and/or stacking) etc. These pallet dimensions are merely by way of example and there are many other standard sizes for pallets, but the principles remain the same—that different sizes of pallets are required to meet the different needs of pallet transportation and if a pallet is made in any size, it will either not be possible to use it in other applications or its use in other applications will compromise on its performance (in terms of space utilisation, pallet weight, load capacity, or the like). However, with the use of the accessory 84, the pallet 10 of the present invention can be used as a larger pallet, when the accessories 84 are fitted and can later be used as a smaller pallet, when the accessories 84 are removed—and vice versa. This supplements the ability to change the other properties of the pallet 10 by including or excluding the bottom accessory 14, as described above.

As an example of the versatility the accessories 14,84 provide, the pallet of the present invention can be used as a large, light weight, one-way pallet to distribute products from manufacturers (as is presently done on wooden pallets that are discarded). Once the products have been delivered, the pallets 10 can be converted to smaller sizes by removing the accessories 84 and/or can be given more strength by adding the accessories 14, as and when required.

It is also possible to make the accessory 84 of an impact absorbing material, such as rubber, to protect the load deck 16.

Referring to FIG. 19, a corner sleeve 90 is shown that can be used with the pallet 10. The sleeve is made of a suitable durable material, preferably a material that can absorb shocks and protect the pallet, e.g. rubber or a thermoplastic elastomer. The sleeve 90 has an internal cavity 92 that is shaped and dimensioned to fit snugly around a pillar 38 of the main body 12 of the pallet and the cavity is open at its top and bottom ends. Two hook formations 70 are provided at the top of the sleeve 90 in a perpendicular arrangement relative to each other. The hook formations 70 are shaped similarly or identically to those of the deck extension accessory 84 and the edge insert 68 described above and can be received in a recess 26 of the load deck 16. At its lower end, the sleeve 90 has two protuberances 94 that are receivable in the recesses 48 of the bottom accessories 14.

The corner sleeve 90 is fitted to a corner of the main body 12 by sliding it over a pillar 38 and clipping the hook formations 70 into recesses on opposing sides of the load deck's corner. The engagement of the sleeve 90 around the pillar 38 and of the hook formations 70 in the apertures 26 hold the sleeve 90 firmly in place on the main body 12, irrespective of whether or not the main body 12 is fitted with a bottom accessory 14. When a bottom accessory 14 is fitted on the main body 12, the lower end of the pillar 38 (which protrudes below the sleeve 90) is received in the recess 48 of the bottom accessory 14 in the normal way, with the protuberances 94 on either side of it.

The sleeve 90 has upper walls 96 that extend around the corner of the load deck 16, has lower walls 98 that extend around the corner of the bottom accessory 14 and has spaced ribs 100 between these walls 96,98. The walls 96,98 and ribs 100 protect the corners of the pallet 10 against impact.

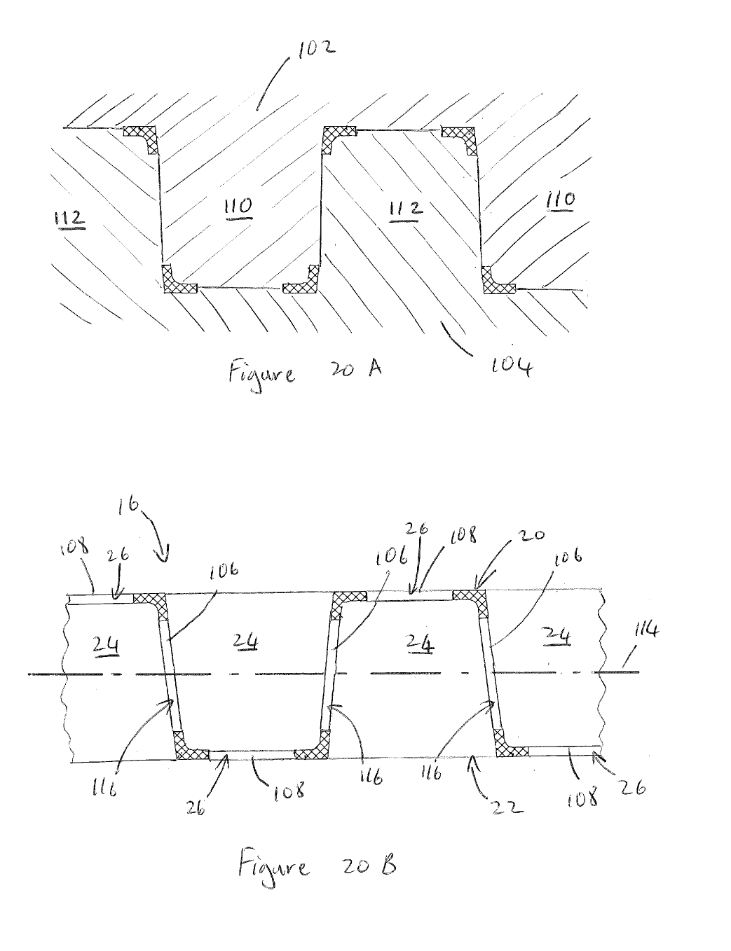

Referring to FIGS. 20A and 20B, when manufacturing the main body 12, an upper mould part 102 and a lower mould part 104 are pressed together and mouldable material, preferably molten polymeric material reinforced with long glass fibres, is injected into the mould cavity of the two-part mould to form the main body. Once the moulded material has solidified, the mould parts 102 and 104 are moved apart (i.e. the mould is opened) and the main body 12 is de-moulded (i.e. removed from the mould).

As can be seen in FIG. 20B, the load deck 16 comprises of an array of cube structures, each extending around one of the cavities 24. Each cube structure comprises four webs 106 on four sides of the cavity 24 and a flange at the top or bottom of the cavity. The cube structure thus extends on five of the six orthogonal sides of the cavity 24—leaving one side (to or bottom) open. The deck 16 is configured such that cavities 26 that are open to the load surface 20 and cavities that are open to the under surface 22 alternate and the result is that the webs 106 and flanges 108 have a castellated cross-sectional profile as shown in FIG. 20B. Apertures 26 are formed in the centre of each of the flanges 108 shown in FIG. 20B so that each flange forms a frame around its aperture and this aperture reduces the weight of the main body 12 and provides for the attachment of grommets (shown in FIG. 10 with reference numeral 60). The part of the flange 108 that extends around each aperture 26 adds to the rigidity of the load deck 16 and assists in forming a contiguous load surface 20 or under surface 22, as the case may be.

As can be seen in FIG. 20A, the castellated profile of the load deck 16 is formed in the single injection moulding step described above by intermittent protuberances 110 that extend downwardly from the upper mould part 102, that are received between upwardly extending protuberances 112 of the lower mould part 104. In order for the moulded load deck 16 to be de-moulded easily, each of the webs 106 has a slightly angled orientation, i.e. it extends at an obtuse (non vertical) angle relative to the load surface 20 and/or under surface 22.

The main purpose of the webs 106 is to provide strength to the load deck 16 and more particularly, to ad stiffness to the load deck and prevent deflection under loads. In this regard, each web 106 acts as a longitudinal beam extending under the load surface 20 an in order to provide stiffness, the web's cross sectional profile should preferably have a large second moment of area, in relation to its neutral axis 114. As can be seen in FIG. 20A, the sides of the protuberances 110 and 112 are in contact in the vicinities of the centres of each of the webs 106, so that apertures 116 are formed in each of the webs, in the vicinity of the neutral axis 114. The result is that each web 106 has material at its top and bottom, i.e. in the regions of its upper and lower edges, that is integrally connected to the flanges 108 and this material in each web 106 has a large second moment of area, because it is relatively far from the neutral axis 114. Each web 106 can thus provide great stiffness as a result of its high second moment of area, but is light in weight because of material saved by forming the apertures 116. These webs 106 with their apertures 116 extend in two perpendicular, axial directions underneath the load deck 16 and the result is that the load deck is exceptionally strong for its weight.

In embodiments of the invention where the main body 12 can be nested and the accessory 14 can be nested, when the main body and accessory are not attached together, the pallet 10 (comprising the main body 12 and attached accessory 14) can carry a load of more than 2800 lbs for longer than 30 days with a 50% factor of safety in a warehouse rack where the pallet is only supported on two opposing feet and it does not bend more than 20 mm after 30 days.

The main body 12 (without the accessory 14 attached) can carry a dynamic load of up to 2800 lbs when a forklift is carrying the accessory and its load for loading into containers, trucks or the like, without the load deck 16 bending to the extent that goods carried on the load deck fall off.

The main body 12 can be used to export goods in shipping containers instead of a much heavier wooden pallet (of about 65 lbs) on what is commonly referred to as “export pallets”, “one way pallets”, or “white” pallets. Conventional export pallets use about 33% less wood than what an equivalent size pallet that satisfies the requirements for pool pallets (where a pool pallet means a re-usable returnable pallet that can be rented on an issue fee (trip fee) basis to a client instead of the client buying new pallets).

The two piece pallet 10 of the present invention, together with the removable deck extension accessories 84, provides the flexibility to compete with the conventional “white” one-way export pallet on price for the first export shipment (i.e. where the price of the main body 12 is compared to the price of a “white” pallet) and then instead of land-filling, discarding or using the “white” pallets' wood for repairs of other wooden pallets, using the main body 12 as an integral part of a new fast moving consumer goods (FMCG) pool pallet that is stackable, rackable and durable, once the deck extensions accessories 84 are removed from the pallet. This way the cost of manufacturing the main body 12 again is avoided. In the wooden pallet case there is a lot of waste as the wooden “white” pallet is the wrong size and is not durable enough and thus cannot be used as an FMCG pallet and is manufactured for only one way use—as one of its names suggest. The present invention could assist greatly in reducing deforestation—especially if the pallet 10 becomes a standard. This advantage is further amplified by commercial benefit, since disposal fees are becoming payable in countries receiving goods on a pallet, in an attempt to discourage land-filling and improper use of the world's natural resources

The main body 12 can be manufactured for the export market where the main body is the size required in the destination country e.g. 40 by 48 inches with a height of less than 5.72 inches for the USA, and deck extension accessories 84 can be attached around the pallet's load deck to extend the load deck horizontally to increase the size of the load deck for the optimal use for export in containers. This enlargement can be to any suitable size, e.g. to a size of 52×44 inches. The deck extension accessory 84 can be removed, leaving a rackable, durable pallet with size 40×48 inches, the accessory 14 can be attached to the main body 12 to make the pallet 10 a durable pool pallet for use in the FMCG trade.

The main body 12 with the deck extension accessories 84 that enlarge the load deck, is also nestable.

The pallet 10 can be dismantled easily by unclipping the accessory 14 from the feet 18, when it needs to be transported empty and the main bodies 12 and accessories 14 can be transported in separate nested arrangements. In typical scenarios, the same number of pallets 10 can be transported in five trucks as conventional “white” pallets can be transported in twelve trucks at present, because of the reduced volume occupied by the nested parts of the pallet 10. This allows substantial payload cost savings in containers and on trucks, aeroplanes and trains and will have a major impact on the environment and carbon footprint reduction of the world.

The pallet 10 weighs less than 44 lbs in any embodiment where it has a load deck size commonly used, but with a load deck size of 40×48 inches, it weighs less than 35 lbs and it is expected to be the lowest weight pallet satisfying the requirement of the FMCG market for racking, stacking and/or durability.

When goods are carried on the pallet 10, the client can add an extra 60 lbs payload on the pallet as this is the difference between the weights of conventional wooden pallets and the pallet 10, allowing about 1500 lbs on a 53 foot truck and about 1000 lbs extra weight in a 40 foot container to be carried free of charge, by utilizing the pallet weight differential between the wooden pallet and this pallet.

Penalties that result from pallets becoming overweight, e.g. with weight gained by water drenching in rain, inconsistent water levels in pallets, etc. are avoided with the pallet 10 and the load can be optimally controlled without traffic and other penalties being incurred.

For every 52 trucks-loads using the pallet 10, there is a saving of one complete truck load—from a CO2 carbon footprint perspective or put differently, 1400 lbs of additional product can be carried on every 53 foot truck load—at no additional cost. The corner sleeve 90 that can be moulded from a thermoplastic elastomer (TPE) or rubbery compound, can be used to avoid impact on the corners of the pallet 10 to increase the serviceable life of the pallet, before it needs to be recycled. Breakages from dropping the pallets 10 on their corners will also be reduced by the corner sleeve 90. The corner sleeve 90 cannot be removed from the pallet 10 while the pallet is assembled with the main body 12 and accessory 14 attached together.

The present invention allows for the use of strapping tape to secure and strengthen the feet 18 of the main body 12 when it is used without the accessory 14.

In another embodiment of the present invention, the middle foot 18 of the main body 12 can be made the same with the same configuration as the second attachment formations 42 of the accessory 14 and the corresponding middle attachment formation of the accessory 14 can be made with the same configuration as a foot 18 of the main body—i.e. the middle foot 18 and middle second attachment formation 42 as shown in the drawings, can be inverted.

1. A pallet comprising a main body, said main body comprising:
a load deck with a generally planar load surface, said load deck defining a plurality of cavities that are each open on at least one side and said load deck including a plurality of webs extending at least partly between adjacent cavities; and
a plurality of spaced-apart feet protruding from the load deck on a side that is opposite from the load surface, said feet including at least one corner foot in each of four corner regions of the body, the feet serving as supports to keep the load deck elevated and the spaces between the feet providing access for inserting lifting devices underneath the load deck;
wherein at least some of the webs extend at an obtuse angle relative to the load deck and at least some of said webs define apertures between an upper edge and a lower edge of each such web.

2. A pallet as claimed in claim 1, wherein the load deck has a depth exceeding 20 mm.

3. A pallet as claimed in claim 2, wherein the load deck has a depth of about 36 mM.

4. A pallet as claimed in claim 1, wherein the load deck includes flanges extending generally co-planar with the load surface.

5. A pallet as claimed in claim 4, wherein said flanges extend from upper edges of the webs of the load deck and define apertures in the load deck, between adjacent webs.

6. A pallet as claimed in claim 1, wherein the load deck defines an under surface that extends generally parallel to the load surface, between the feet and said load deck includes flanges extending generally co-planar with the under surface.

7. A pallet as claimed in claim 6, wherein said flanges extend from lower edges of the webs of the load deck and define apertures in the load deck, between adjacent webs.

8. A pallet as claimed in claim 1, wherein the main body is made of a fibre reinforced polymeric material and weighs less than 44 lbs.

9. A pallet as claimed in claim 8, wherein the load surface has dimensions of about 40×48 inches as the pallet weighs less than 35 lbs.

10. A pallet as claimed in claim 1, wherein each of the feet is of a hollow construction with tapering walls, such that the feet of one such body are partly receivable inside the feet of another such body in a nesting manner.

11. A pallet as claimed in claim 1, which further includes an accessory and wherein at least each corner foot defines at least one first attachment formation that is attachable to the accessory of the pallet, such that the accessory extends at least between the attachment formations of the corner feet.

12. A pallet comprising a main body, said main body comprising:
a load deck with a generally planar load surface, said load deck defining a plurality of cavities that are each open on at least one side with webs extending at least partly between adjacent cavities; and
a plurality of spaced-apart feet protruding from the load deck on a side that is opposite from the load surface, said feet including at least one corner foot in each of four corner regions of the body, the feet serving as supports to keep the load deck elevated and the spaces between the feet providing access for inserting lifting devices underneath the load deck, each of said feet being of a hollow construction with tapering walls, such that the feet of one such body are partly receivable inside the feet of another such body in a nesting manner;
wherein each foot defines at least one tapered recess extending from the bottom of the foot, towards the load deck.

13. A pallet as claimed in claim 12 in which at least one of the recesses extends from the bottom of its associated foot to the vicinity of the load deck and said foot includes a structure that is generally aligned with the load deck and spans the recess.

14. A pallet as claimed in claim 13, wherein the body is dimensioned such that, when an upper such body is nested on top of a lower such a body, the underside of the structures spanning the load recesses of the upper body's feet, rests in abutment on the load surface of the lower body, such that the abutment between said structures of the upper and lower bodies prevent the feet of the upper body from entering the insides of the feet of the lower body beyond a predetermined extent.

15. A pallet as claimed in claim 13, wherein said structure is in the form of a cross member.

16. A pallet as claimed in claim 12, wherein said pallet includes at least nine feet, including the four corner feet, and wherein each of said corner feet has at least one of said recesses that divides the corner foot into at least two pillars.

17. A pallet as claimed in claim 16, wherein said pallet includes at least nine feet and each one of said feet has at least one of said recesses that divides the foot into at least two pillars, such that the pallet has at least eighteen of said pillars.

18. A pallet comprising a main body and an accessory, the main body defining an open load deck with a plurality of cavities that are each open on at least one side, said load deck defining a generally planar load surface and a plurality of spaced-apart feet protruding from the body on a side that is opposite from the load surface, said feet including at least one corner foot in each of four corner regions of the body, the feet serving as supports to keep the load deck elevated and the spaces between the feet providing access for inserting lifting devices underneath the load deck; wherein each of the feet is of a hollow construction with tapering walls, such that the feet of one such body are partly receivable inside the feet of another such body in a nesting manner and wherein each corner foot defines at least one first attachment formation that is attachable to the accessory of the pallet, such that the accessory extends at least between the attachment formations of the corner feet; wherein said accessory is also of an open construction, defining a plurality of cavities that are each open on at least one side.

19. A pallet as claimed in claim 18, in which feet recesses are defined in undersides of the feet and accessory protuberances are defined on the accessory, the accessory protuberances being receivable in the feet recesses, at least in part.

20. A pallet as claimed in claim 19, in which each of the accessory protuberances is of a hollow construction with tapering walls, such that the accessory protuberances of one such accessory are partly receivable inside the accessory protuberances of another such accessory in a nesting manner.

21. A pallet as claimed in claim 18, wherein the accessory includes a plurality of second attachment formations that are attachable to the first attachment formations on at least some of the feet and the accessory defines a plurality of accessory recesses in which the feet are receivable, at least in part, said second attachment formations being disposed inside the accessory recesses, where they are protected against damage.

22. A pallet as claimed in claim 18, wherein the accessory defines at least one beam extending between at least some of the feet when the accessory is attached to the feet, said beam being of an open construction defining a plurality of cavities that are each open on at least one side.

23. A pallet as claimed in claim 18, wherein the accessory defines at least one beam extending between at least some of the feet when the accessory is attached to the feet, and wherein the accessory is dimensioned such that, when an upper such accessory is nested on top of a lower such accessory, the undersides of the upper accessory's beams rest in abutment on the beams of the lower accessory, such that the abutment between the beams of the upper and lower accessories prevent the upper body from entering the accessory recesses of the lower accessory beyond a predetermined extent.

24. A pallet as claimed in claim 18, in which the attachment formations are releasable.

25. A pallet as claimed in claim 24, in which the attachment formations include clip formations and wherein the pallet defines release apertures through which a release element can be inserted to release the clip formations.

26. A pallet as claimed in claim 18, which defines a plurality of apertures in a top surface of its load deck, in which inserts are receivable.

27. A pallet as claimed in claim 18, which defines a plurality of recesses in an underside of its load deck, in which inserts are receivable.

28. A pallet as claimed in claim 22, which defines a plurality of apertures on upper sides of the beams, in which inserts are receivable.

29. A pallet as claimed in claim 22, which defines a plurality of recesses on undersides of the beams, in which inserts are receivable.

30. A pallet as claimed in claim 26, which includes a plurality of said inserts that are receivable in the apertures, each insert being of a slip resistant material.

31. A pallet as claimed in claim 27, which includes a plurality of said inserts that are receivable in the apertures, each insert being of a slip resistant material.

32. A pallet as claimed in claim 28, which includes a plurality of said inserts that are receivable in the apertures, each insert being of a slip resistant material.

33. A pallet as claimed in claim 29, which includes a plurality of said inserts that are receivable in the apertures, each insert being of a slip resistant material.

34. A pallet as claimed in claim 18, which includes at least one corner sleeve that can be attached to a foot of the main body by extending around at least part of the foot, said corner sleeve being held captive on the foot between the accessory and the load deck, when the accessory is attached to the first attachment formations.

35. A process for manufacturing a pallet with a load deck, said process including:
closing two parts of a two-part mould to form a mould cavity;
injecting mouldable material into the mould cavity;
allowing the mouldable material to solidify to form the pallet; and
de-moulding the pallet;
wherein the pallet includes a plurality of webs in its load deck, each web being oriented at an obtuse angle relative to the load deck, and wherein the two parts of the two-part mould abut in the vicinity of a neutral axis of at least some of said webs, when the mould is closed, to define an aperture in the web in the vicinity of its neutral axis.

36. A process as claimed in claim 35, wherein the mouldable material is a fibre reinforced polymeric material.

37. A method for providing pallets for the handling of goods, said method comprising:
providing a pallet body defining an open load deck defining a plurality of cavities that are each open on at least one side, said load deck having a generally planar load surface and a plurality of spaced-apart feet protruding from the body on a side that is opposite from the load surface, said feet including at least one corner foot in each of four corner regions of the body, the feet serving as supports to keep the load deck elevated and the spaces between the feet providing access for inserting lifting devices underneath the load deck;
loading goods onto the load deck of the pallet body;
transporting the pallet body with the goods loaded on top of it; and
attaching an accessory to the feet of the pallet body such that the accessory extends at least between the four corner feet in a manner such that the accessory is spaced from the load deck.

38. A method as claimed in claim 37, wherein the load deck of the pallet body includes a plurality of webs extending at least partly between adjacent cavities, at least some of the webs extend at an obtuse angle relative to the load deck and at least some of said webs define apertures between an upper edge and a lower edge of each such web.

39. A method as claimed in claim 37, which includes supporting the pallet on opposing sides in a racking system, after attaching the accessory to the feet of the pallet.

40. A method as claimed in claim 37, which includes off-loading the goods before attaching the accessory to the feet of the pallet body.

41. A method as claimed in claim 37, which includes an additional step of releasing the attachment of the accessory from the feet of the pallet body.

42. A method as claimed in claim 41, which includes re-attaching the accessory to the feet of the pallet body.

43. A method as claimed in claim 37, wherein each of the pallet body's feet is of a hollow construction with tapering walls and wherein said method includes the step of transporting a plurality of said pallet bodies in a nesting arrangement, with the feet of one such body partly received inside the feet of another such body in a nesting manner, before loading the pallet body with goods.

44. A method as claimed in claim 37, wherein each of the pallet body's feet is of a hollow construction with tapering walls and wherein said method includes the step of transporting a plurality of said pallet bodies in a nesting arrangement, with the feet of one such body partly received inside the feet of another such body in a nesting manner, after the goods have been off-loaded and before the accessories are attached to the main bodies.

45. A method as claimed in claim 37, in which the goods to be transported on the pallet body includes a polymer and wherein the method includes manufacturing the pallet body at the location from where the goods are to be transported, using polymer supplied by a sender seeking to transport the polymer.

46. A method as claimed in claim 37, which includes repeatedly using the pallet after attaching the accessory to the feet of the pallet body.

47. A method as claimed in claim 46, which includes renting out the pallet as part of a pool of pallets, after attaching the accessory to the main body.

48. A method as claimed in claim 37, which includes removably attaching at least one deck extension accessory to at least one edge of the load deck of the pallet body.

49. A method as claimed in claim 48, in which the load deck has a size of about 40×48 inches and the load surface of the pallet is increased to 52×44 inches with the addition of the deck extension accessory.
